(19) United States
(12) Patent Application Publication
(10) Pub. No.: US 2024/0220319 A1
(43) Pub. Date: Jul. 4, 2024

(54) AUTOMATED VISUAL INFORMATION CONTEXT AND MEANING COMPREHENSION SYSTEM

(71) Applicant: QOMPLX LLC, Reston, VA (US)

(72) Inventors: Jason Crabtree, Vienna, VA (US); Andrew Sellers, Monument, CO (US)

(21) Appl. No.: 18/597,946

(22) Filed: Mar. 7, 2024

Related U.S. Application Data
(63) Continuation of application No. 17/088,387, filed on Nov. 3, 2020.
Application No. 17/088,387 is a continuation-in-part of application No. 16/945,698, filed on Jul. 31, 2020, now abandoned.
Application No. 16/945,698 is a continuation-in-part of application No. 16/864,133, filed on Apr. 30, 2020, now Pat. No. 11,494,665.
Application No. 16/864,133 is a continuation-in-part of application No. 15/847,443, filed on Dec. 19, 2017, now abandoned.
Application No. 15/847,443 is a continuation-in-part of application No. 15/790,457, filed on Oct. 23, 2017, now Pat. No. 10,884,999.
Application No. 15/790,457 is a continuation-in-part of application No. 15/790,327, filed on Oct. 23, 2017, now Pat. No. 10,860,951.
Application No. 15/790,327 is a continuation-in-part of application No. 15/616,427, filed on Jun. 7, 2017, now abandoned.
Application No. 15/616,427 is a continuation-in-part of application No. 15/141,752, filed on Apr. 28, 2016, now Pat. No. 10,860,962.
Application No. 15/141,752 is a continuation-in-part of application No. 15/091,563, filed on Apr. 5, 2016, now Pat. No. 10,204,147.
Application No. 15/091,563 is a continuation-in-part of application No. 14/986,536, filed on Dec. 31, 2015, now Pat. No. 10,210,255.
Application No. 14/986,536 is a continuation-in-part of application No. 14/925,974, filed on Oct. 28, 2015, now abandoned.
Application No. 17/088,387 is a continuation-in-part of application No. 16/945,698, filed on Jul. 31, 2020, now abandoned.
Application No. 16/945,698 is a continuation-in-part of application No. 16/864,133, filed on Apr. 30, 2020, now Pat. No. 11,494,665.
Application No. 16/864,133 is a continuation-in-part of application No. 15/847,443, filed on Dec. 19, 2017, now abandoned.
Application No. 15/847,443 is a continuation-in-part of application No. 15/616,427, filed on Jun. 7, 2017, now abandoned.
Application No. 15/616,427 is a continuation-in-part of application No. 14/925,974, filed on Oct. 28, 2015, now abandoned.
Application No. 17/088,387 is a continuation-in-part of application No. 16/945,698, filed on Jul. 31, 2020, now abandoned.
Application No. 16/945,698 is a continuation-in-part of application No. 16/864,133, filed on Apr. 30, 2020, now Pat. No. 11,494,665.
Application No. 16/864,133 is a continuation-in-part of application No. 15/847,443, filed on Dec. 19, 2017, now abandoned.
Application No. 15/847,443 is a continuation-in-part of application No. 15/489,716, filed on Apr. 17, 2017, now abandoned.
Application No. 15/489,716 is a continuation-in-part of application No. 15/409,510, filed on Jan. 18, 2017, now abandoned.
Application No. 15/409,510 is a continuation-in-part of application No. 15/379,899, filed on Dec. 15, 2016, now abandoned.
Application No. 15/379,899 is a continuation-in-part of application No. 15/376,657, filed on Dec. 13, 2016, now Pat. No. 10,402,906.
Application No. 15/376,657 is a continuation-in-part of application No. 15/237,625, filed on Aug. 15, 2016, now Pat. No. 10,248,910.
Application No. 15/237,625 is a continuation-in-part of application No. 15/206,195, filed on Jul. 8, 2016, now abandoned.
Application No. 15/206,195 is a continuation-in-part of application No. 15/186,453, filed on Jun. 18, 2016, now abandoned.
Application No. 15/186,453 is a continuation-in-part of application No. 15/166,158, filed on May 26, 2016, now abandoned.
Application No. 15/166,158 is a continuation-in-part of application No. 15/141,752, filed on Apr. 28, 2016, now Pat. No. 10,860,962.
Application No. 17/088,387 is a continuation-in-part of application No. 16/945,698, filed on Jul. 31, 2020, now abandoned.
Application No. 16/945,698 is a continuation-in-part of application No. 16/915,176, filed on Jun. 29, 2020, now abandoned.
Application No. 16/915,176 is a continuation-in-part of application No. 15/847,443, filed on Dec. 19, 2017, now abandoned.
Application No. 15/847,443 is a continuation-in-part of application No. 15/891,329, filed on Feb. 7, 2018, now abandoned.
Application No. 15/891,329 is a continuation-in-part of application No. 15/860,980, filed on Jan. 3, 2018, now abandoned.
Application No. 15/860,980 is a continuation-in-part of application No. 15/850,037, filed on Dec. 21, 2017, now abandoned.
Application No. 15/850,037 is a continuation-in-part of application No. 15/489,716, filed on Apr. 17, 2017, now abandoned.
Application No. 15/489,716 is a continuation-in-part of application No. 15/673,368, filed on Aug. 9, 2017, now abandoned.
Application No. 15/673,368 is a continuation-in-part of application No. 15/376,657, filed on Dec. 13, 2016, now Pat. No. 10,402,906.
Application No. 17/088,387 is a continuation-in-part of application No. 16/945,698, filed on Jul. 31, 2020, now abandoned.
Application No. 16/945,698 is a continuation-in-part of application No. 16/915,176, filed on Jun. 29, 2020, now abandoned.
Application No. 16/915,176 is a continuation-in-part of application No. 15/891,329, filed on Feb. 7, 2018, now abandoned.
Application No. 15/891,329 is a continuation-in-part of application No. 15/860,980, filed on Jan. 3, 2018, now abandoned.
Application No. 15/860,980 is a continuation-in-part of application No. 15/788,002, filed on Oct. 19, 2017, now abandoned.
Application No. 15/788,002 is a continuation-in-part of application No. 15/787,601, filed on Oct. 18, 2017, now Pat. No. 10,860,660.
Application No. 15/787,601 is a continuation-in-part of application No. 15/616,427, filed on Jun. 7, 2017, now abandoned.
Application No. 17/088,387 is a continuation-in-part of application No. 16/945,698, filed on Jul. 31, 2020, now abandoned.
Application No. 16/945,698 is a continuation-in-part of application No. 16/915,176, filed on Jun. 29, 2020, now abandoned.
Application No. 16/915,176 is a continuation-in-part of application No. 15/905,041, filed on Feb. 26, 2018, now Pat. No. 10,706,063.
Application No. 15/905,041 is a continuation-in-part of application No. 15/237,625, filed on Aug. 15, 2016, now Pat. No. 10,248,910.
Application No. 17/088,387 is a continuation-in-part of application No. 16/945,698, filed on Jul. 31, 2020, now abandoned.
Application No. 16/945,698 is a continuation-in-part of application No. 15/931,534, filed on May 13, 2020, now abandoned.
Application No. 15/931,534 is a continuation-in-part of application No. 16/777,270, filed on Jan. 30, 2020, now Pat. No. 11,025,674.
Application No. 16/777,270 is a continuation-in-part of application No. 16/720,383, filed on Dec. 19, 2019, now Pat. No. 10,944,795.
Application No. 16/720,383 is a continuation-in-part of application No. 15/823,363, filed on Nov. 27, 2017, now Pat. No. 10,560,483.
Application No. 15/823,363 is a continuation-in-part of application No. 15/725,274, filed on Oct. 4, 2017, now Pat. No. 10,609,079.
Application No. 15/725,274 is a continuation-in-part of application No. 15/655,113, filed on Jul. 20, 2017, now Pat. No. 10,735,456.
Application No. 15/655,113 is a continuation-in-part of application No. 15/616,427, filed on Jun. 7, 2017, now abandoned.
Application No. 17/088,387 is a continuation-in-part of application No. 16/945,698, filed on Jul. 31, 2020, now abandoned.
Application No. 16/945,698 is a continuation-in-part of application No. 15/931,534, filed on May 13, 2020, now abandoned.
Application No. 15/931,534 is a continuation-in-part of application No. 15/683,765, filed on Aug. 22, 2017, now abandoned.
Application No. 15/683,765 is a continuation-in-part of application No. 15/409,510, filed on Jan. 18, 2017, now abandoned.
Application No. 17/088,387 is a continuation-in-part of application No. 16/945,698, filed on Jul. 31, 2020, now abandoned.
Application No. 16/945,698 is a continuation-in-part of application No. 15/931,534, filed on May 13, 2020, now abandoned.
Application No. 15/931,534 is a continuation-in-part of application No. 16/718,906, filed on Dec. 18, 2019, now Pat. No. 11,055,140.
Application No. 16/718,906 is a continuation of application No. 15/879,182, filed on Jan. 24, 2018, now Pat. No. 10,514,954.
Application No. 15/879,182 is a continuation-in-part of application No. 15/850,037, filed on Dec. 21, 2017, now abandoned.
Application No. 17/088,387 is a continuation-in-part of application No. 16/945,698, filed on Jul. 31, 2020, now abandoned.
Application No. 16/945,698 is a continuation-in-part of application No. 15/931,534, filed on May 13, 2020, now abandoned.
Application No. 15/931,534 is a continuation-in-part of application No. 15/905,041, filed on Feb. 26, 2018, now Pat. No. 10,706,063.
Application No. 17/088,387 is a continuation-in-part of application No. 16/945,698, filed on Jul. 31, 2020, now abandoned.
Application No. 16/945,698 is a continuation-in-part of application No. 15/931,534, filed on May 13, 2020, now abandoned.
Application No. 15/931,534 is a continuation-in-part of application No. 16/191,054, filed on Nov. 14, 2018, now Pat. No. 10,681,074.
Application No. 16/191,054 is a continuation-in-part of application No. 15/655,113, filed on Jul. 20, 2017, now Pat. No. 10,735,456.
Application No. 15/655,113 is a continuation-in-part of application No. 15/237,625, filed on Aug. 15, 2016, now Pat. No. 10,248,910.
Application No. 17/088,387 is a continuation-in-part of application No. 16/945,698, filed on Jul. 31, 2020, now abandoned.
Application No. 16/945,698 is a continuation-in-part of application No. 15/931,534, filed on May 13, 2020, now abandoned.
Application No. 15/931,534 is a continuation-in-part of application No. 16/654,309, filed on Oct. 16, 2019, now abandoned.
Application No. 16/654,309 is a continuation-in-part of application No. 15/847,443, filed on Dec. 19, 2017, now abandoned.
Application No. 17/088,387 is a continuation-in-part of application No. 16/945,698, filed on Jul. 31, 2020, now abandoned.
Application No. 16/945,698 is a continuation-in-part of application No. 15/931,534, filed on May 13, 2020, now abandoned.
Application No. 15/931,534 is a continuation-in-part of application No. 16/660,727, filed on Oct. 22, 2019, now Pat. No. 10,938,683.
Application No. 16/660,727 is a continuation of application No. 15/229,476, filed on Aug. 5, 2016, now Pat. No. 10,454,791.
Application No. 15/229,476 is a continuation-in-part of application No. 15/206,195, filed on Jul. 8, 2016, now abandoned.
(60) Provisional application No. 62/568,298, filed on Oct. 4, 2017.
(60) Provisional application No. 62/568,291, filed on Oct. 4, 2017.
(60) Provisional application No. 62/568,305, filed on Oct. 4, 2017.
(60) Provisional application No. 62/568,312, filed on Oct. 4, 2017.

(51) Int. Cl. G06F 9/50; G06N 5/025; G06Q 10/067; G06Q 30/0201; G06Q 30/0204; G06Q 40/04

(52) U.S. Cl. CPC G06F 9/5011; G06N 5/025; G06Q 10/067; G06Q 30/0201; G06Q 30/0205; G06Q 40/04

(57) ABSTRACT

A system for analyzing images and video that is capable of recognizing, classifying, and processing the context and meaning contained therein in a manner similar to human intuitive understanding of such context and meaning. Images and video are gathered through a crowdsourcing portal, cameras, and other remote sensing devices. Real world data relevant to the images and video is gathered using a deep web collection and extraction engine. The resulting inputs are analyzed for context and meaning using machine learning algorithms, whose outputs, or resulting models, are reviewed and adjusted by humans through a crowdsourcing or collaborative labor portal.

### CROSS-REFERENCE TO RELATED APPLICATIONS

Priority is claimed in the application data sheet to the following patents or patent applications, each of which is expressly incorporated herein by reference in its entirety:
U.S. application Ser. No. 17/088,387
U.S. application Ser. No. 16/945,698
U.S. application Ser. No. 16/864,133
U.S. application Ser. No. 15/847,443
U.S. application Ser. No. 15/790,457
62/568,298
U.S. application Ser. No. 15/790,327
62/568,291
U.S. application Ser. No. 15/616,427
U.S. application Ser. No. 15/141,752
U.S. application Ser. No. 15/091,563
U.S. application Ser. No. 14/986,536
U.S. application Ser. No. 14/925,974
U.S. application Ser. No. 15/489,716
U.S. application Ser. No. 15/409,510
U.S. application Ser. No. 15/379,899
U.S. application Ser. No. 15/376,657
U.S. application Ser. No. 15/237,625
U.S. application Ser. No. 15/206,195
U.S. application Ser. No. 15/186,453
U.S. application Ser. No. 15/166,158
U.S. application Ser. No. 16/915,176
U.S. application Ser. No. 15/891,329
U.S. application Ser. No. 15/860,980
U.S. application Ser. No. 15/850,037
U.S. application Ser. No. 15/673,368
U.S. application Ser. No. 15/788,002
62/568,305
U.S. application Ser. No. 15/787,601
62/568,312
U.S. application Ser. No. 15/905,041
U.S. application Ser. No. 15/931,534
U.S. application Ser. No. 16/777,270
U.S. application Ser. No. 16/720,383
U.S. application Ser. No. 15/823,363
U.S. application Ser. No. 15/725,274
U.S. application Ser. No. 15/655,113
U.S. application Ser. No. 15/683,765
U.S. application Ser. No. 16/718,906
U.S. application Ser. No. 15/879,182
U.S. application Ser. No. 16/191,054
U.S. application Ser. No. 16/654,309
U.S. application Ser. No. 16/660,727
U.S. application Ser. No. 15/229,476

### BACKGROUND OF THE INVENTION

### Field of the Invention

The present invention is in the field of computer systems which automatically contextualize, organize, and process the visual content and meaning contained in images and video in a manner similar to human comprehension of such content and meaning.

### Discussion of the State of the Art

Computer image and video content analysis is a relatively new field in computer science. The information contained in images and video is very complex, and the contextual information and meaning contained in images and video has previously only been comprehensible only to humans. While certain types of objects can be recognized by current computer systems (e.g. faces, signs, cars, etc.), the overall context and meaning of the scene has previously not been recognizable or classifiable using computers.

When looking at images and video, human beings intuitively understand a tremendous amount of information about the visual content being viewed, such as locational context, situational context, social relationships, the relationship of objects to the environment, identification of out-of-context or out-of-scale objects, direction of motion, the intent of someone taking an action, the emotions of people and animals within the scene, expected reactions of others within the scene, body language and gestures, and other information and meanings that are not currently captured by existing computer image and video analysis.

Existing image and video analysis tools are very limited in terms of the types of information they can recognize within a scene. They are capable of identifying certain classes of objects such as faces, vehicles, buildings, etc., provided that these objects are properly positioned within the image, are sufficiently in focus, are not obscured, etc. They are capable, to a certain degree, of recognizing those objects in further detail. For example, they may be able to recognize people, the type of vehicle, or a particular building, provided that comparison images of those things are contained in their database. However, current systems are not capable of understanding context, meaning, emotion, intent, and other information that humans understand intuitively.

Existing image and video analysis tools are not able to understand this additional information because they are insufficiently complex. The algorithms used rely primarily on comparison with pre-existing images in a database. Such comparisons, of course, are not sufficiently complex to analyze the vast range of information contained both within the image itself and outside of the image as contextual information that may shed light on the meaning of the image. For example, contextual information such as location, lighting, time of day, weather conditions, types of vehicles, clothing or uniforms worn by people, facial expressions, and direction of motion can all have a dramatic impact on the meaning of the image and video under analysis.

Further, existing systems are not capable of taking into account data degradation. Many types of data are valid only for certain periods of time, and become less relevant or even potentially misleading as real world conditions change over time. Image comparison databases cannot account for this degradation in information utility.

What is needed is an image and video analysis system that combines the entire range of contextual information available on the internet with a variety of powerful image analysis tools using machine learning algorithms to identify the content and meaning contained in images and video in a manner similar to the way in which humans intuitively understand such content and meaning when viewing images and video.

### SUMMARY OF THE INVENTION

The inventor has developed an image and video analysis system that is capable of recognizing, classifying, and processing the context and meaning of images and video in a manner similar to human intuitive understanding of such context and meaning. Images and video are gathered from a multiplicity of sources, including at least a crowdsourced image and video portal. Contextual information is gathered which includes the entire range of such information available on the internet including, but not limited to, such things as object recognition, location data, weather and time of day data, news and event data, street-level imaging, other crowdsourced image and video databases, vehicle data, building data, maps, physics engines, human emotional studies. Specialized algorithm databases will contain image analysis tools such as object recognition, human activity identification, physics engines, location identification, facial recognition, body position and action recognition, before and after image comparisons, atmospheric correction and enhancement algorithms. Machine learning algorithms would analyze the images and video using the contextual data and algorithms to identify the content and meaning contained in images and video in a manner similar to the way in which humans intuitively understand such content and meaning when viewing images and video.

In an embodiment, the system would be comprised of a crowdsourcing portal, algorithm databases, and a deep web extraction engine, which provide inputs to a scene comprehension engine. Images and video for analysis would come from a multiplicity of sources, including at least the crowdsourcing portal. Through the crowdsourcing portal, individuals and groups would be enabled to submit the images and video they generate for analysis. The crowdsourcing portal would allow for inputs from a variety of mobile and fixed devices such as smart phones, vehicle-mounted cameras, drones, robots, stationary cameras, etc. Contributions could be either compensated monetarily or through non-monetary incentives, depending on the structure of the platform. The algorithm database would comprise specialized algorithms for image and video processing, including image correction, object recognition and identification (buildings, vehicles, plants/animals, people, etc.), human activity and role recognition and identification (sports, commuting, occupations, etc.), physics engines, location recognition and identification, and the like. A deep web extraction engine would gather real world information from the internet that is relevant to analyzing context and meaning, such as temporospatial information (weather, geopositioning, maps and terrain, etc.), physical world data (vehicle and building information, plant and animal taxonomies, physics models, etc.), and human information (facial expression information, occupation and activity information, brain imaging studies, human kinetics studies, and human emotional response studies, etc.). The scene comprehension engine would be comprised of a variety of machine learning algorithms (for example, generative adversarial networks (GANs), convolutional neural networks (CNNs), and semantic language analysis engines) that would analyze the images and video obtained through the crowdsourcing engine, using the algorithms contained in the algorithm database and the real world information provided by the deep web extraction engine. The result would be a computer-generated classification of the context and meaning of the images and video similar to the manner in which humans would understand such context and meaning, and would be usable for a wide variety of applications not currently possible with existing technology.

According to an embodiment, the following method would be used to automatically contextualize, organize, and process the visual content and meaning contained in images and video in a manner similar to human comprehension. Images and video would be obtained from a multiplicity of sources, including at least a crowdsourcing portal. Real world data would be gathered from a multiplicity of sources, including at least a deep web extraction engine, relevant to comprehension of the context and meaning contained within the images and video. Image and video processing algorithms would be obtained from an algorithm database. Using the algorithms and real-world data, the images and video would be analyzed using at least one machine learning algorithm designed to identify the context and meaning contained in the images and video. The result would be a computer-generated classification of the context and meaning of the images and video similar to the manner in which humans would understand such context and meaning, and would be usable for a wide variety of applications not currently possible with existing technology.

According to a preferred embodiment, a computing system for analysis of images and video that is capable of recognizing, classifying, and processing the context and meaning contained therein in a manner similar to human intuitive understanding of such context and meaning employing a collaborative platform, the computing system comprising: one or more hardware processors configured for: receiving image and video data from a first plurality of sources; allowing individuals and groups to review and annotate classifications and metadata associated with the received image and video data; gathering data from a second plurality of sources on the internet; retrieving real-world data based at least in part on the received images and video from the second plurality of sources; obtaining one or more machine learning algorithms from an algorithm database; and analyzing the received images and video using the retrieved machine learning algorithms to classify and add metadata to the received image and video data.

According to a preferred embodiment, a computer-implemented method executed on a collaborative platform for analysis of images and video that is capable of recognizing, classifying, and processing the context and meaning contained therein in a manner similar to human intuitive understanding of such context and meaning, the computer-implemented method comprising: receiving image and video data from a first plurality of sources; allowing individuals and groups to review and annotate classifications and metadata associated with the received image and video data; gathering data from a second plurality of sources on the internet; retrieving real-world data based at least in part on the received images and video from the second plurality of sources; obtaining one or more machine learning algorithms from an algorithm database; and analyzing the received images and video using the retrieved machine learning algorithms to classify and add metadata to the received image and video data.

According to a preferred embodiment, a system for analysis of images and video that is capable of recognizing, classifying, and processing the context and meaning contained therein in a manner similar to human intuitive understanding of such context and meaning employing a collaborative platform, comprising one or more computers with executable instructions that, when executed, cause the system to: receive image and video data from a first plurality of sources; allow individuals and groups to review and annotate classifications and metadata associated with the received image and video data; gather data from a second plurality of sources on the internet; retrieve real-world data based at least in part on the received images and video from the second plurality of sources; obtain one or more machine learning algorithms from an algorithm database; and analyze the received images and video using the retrieved machine learning algorithms to classify and add metadata to the received image and video data.

According to a preferred embodiment, non-transitory, computer-readable storage media having computer-executable instructions embodied thereon that, when executed by one or more processors of a computing system employing a collaborative platform for analysis of images and video that is capable of recognizing, classifying, and processing the context and meaning contained therein in a manner similar to human intuitive understanding of such context and meaning, cause the computing system to: receive image and video data from a first plurality of sources; allow individuals and groups to review and annotate classifications and metadata associated with the received image and video data; gather data from a second plurality of sources on the internet; retrieve real-world data based at least in part on the received images and video from the second plurality of sources; obtain one or more machine learning algorithms from an algorithm database; and analyze the received images and video using the retrieved machine learning algorithms to classify and add metadata to the received image and video data.

According to an aspect of an embodiment, the first plurality of sources comprises crowdsourced or collaborative data sources.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a diagram of an exemplary architecture for a system for rapid predictive analysis of very large data sets using an actor-driven distributed computational graph, according to one aspect.

FIG. 2 is a diagram of an exemplary architecture for a system for rapid predictive analysis of very large data sets using an actor-driven distributed computational graph, according to one aspect.

FIG. 3 is a diagram of an exemplary architecture for a system for rapid predictive analysis of very large data sets using an actor-driven distributed computational graph, according to one aspect.

FIG. 4 is a diagram of an exemplary architecture for a system for rapid predictive analysis of very large data sets using an actor-driven distributed computational graph, according to one aspect.

FIG. 5 is a diagram of an exemplary architecture for a system where streams of input data from one or more of a plurality of sources are analyzed to predict outcome using both batch analysis of acquired data and transformation pipeline manipulation of current streaming data according to one aspect.

FIG. 6 is a diagram of an exemplary architecture for a linear transformation pipeline system which introduces the concept of the transformation pipeline as a directed graph of transformation nodes and messages according to one aspect.

FIG. 7 is a diagram of an exemplary architecture for a transformation pipeline system where one of the transformations receives input from more than one source which introduces the concept of the transformation pipeline as a directed graph of transformation nodes and messages according to one aspect.

FIG. 8 is a diagram of an exemplary architecture for a transformation pipeline system where the output of one data transformation servers as the input of more than one downstream transformations which introduces the concept of the transformation pipeline as a directed graph of transformation nodes and messages according to one aspect.

FIG. 9 is a diagram of an exemplary architecture for a transformation pipeline system where a set of three data transformations act to form a cyclical pipeline which also introduces the concept of the transformation pipeline as a directed graph of transformation nodes and messages according to one aspect.

FIG. 10 is a process flow diagram of a method for the receipt, processing and predictive analysis of streaming data according to one aspect.

FIG. 11 is a process flow diagram of a method for representing the operation of the transformation pipeline as a directed graph function according to one aspect.

FIG. 12 is a process flow diagram of a method for a linear data transformation pipeline according to one aspect.

FIG. 13 is a process flow diagram of a method for the disposition of input from two antecedent data transformations into a single data transformation of transformation pipeline according to one aspect.

FIG. 14 is a process flow diagram of a method for the disposition of output of one data transformation that then serves as input to two postliminary data transformations according to one aspect.

FIG. 15 is a process flow diagram of a method for processing a set of three or more data transformations within a data transformation pipeline where output of the last member transformation of the set serves as input of the first member transformation thereby creating a cyclical relationship according to one aspect.

FIG. 16 is a process flow diagram of a method for the receipt and use of streaming data into batch storage and analysis of changes over time, repetition of specific data sequences or the presence of critical data points according to one aspect.

FIG. 17 is a process flow diagram for an exemplary method for rapid predictive analysis of very large data sets using an actor-driven distributed computational graph, according to one aspect.

FIG. 18 is a process flow diagram for an exemplary method for rapid predictive analysis of very large data sets using an actor-driven distributed computational graph, according to one aspect.

FIG. 19 is a process flow diagram for an exemplary method for rapid predictive analysis of very large data sets using an actor-driven distributed computational graph, according to one aspect.

FIG. 20 is a block diagram illustrating an exemplary hardware architecture of a computing device.

FIG. 21 is a block diagram illustrating an exemplary logical architecture for a client device.

FIG. 22 is a block diagram showing an exemplary architectural arrangement of clients, servers, and external services.

FIG. 23 is another block diagram illustrating an exemplary hardware architecture of a computing device.

FIG. 24 is a process flow diagram for an exemplary embodiment of a crowd-sourced data gathering system.

FIG. 25 is a diagram showing an exemplary use of an embodiment of a crowd-sourced data gathering system.

FIG. 26 is a diagram showing an exemplary representation of the client direction and operator visual feedback aspect of a video streaming embodiment of a crowd-sourced data gathering system.

FIG. 27 is a process flow diagram showing an exemplary representation of a universal collection of computing algorithms and a marketplace for clients and developers of such algorithms.

FIG. 28 is a diagram showing an exemplary representation of the usage of a universal collection of computing algorithms by an individual client with simple computing needs.

FIG. 29 is a diagram showing an exemplary representation of the usage of a universal collection of computing algorithms by a large commercial enterprise client with complex computing needs.

FIG. 30 is a block diagram showing an exemplary representation of a collaborative algorithm development, deployment, and tuning platform as applied to the field of quantitative securities trading.

FIG. 31 is a block diagram showing additional detail regarding the collaborative group formation portal aspect of a collaborative algorithm development, deployment, and tuning platform.

FIG. 32 is a process flow diagram showing the major steps involved in use of an embodiment by individuals and groups.

FIG. 33 is a process flow diagram showing the major steps involved in use of an aspect of an embodiment involving allocation of tasks depending on whether they are intuitive or computational in nature.

FIG. 34 is a conceptual diagram of the types of inputs that will be used an aspect, the compensation allocation engine, to allocate compensation among the group members based on a predictive calculation of that member's expected contributions in developing algorithms and strategies.

FIG. 35 is a block diagram showing an exemplary representation of a system for recognizing, classifying, and processing the context and meaning of images and video in a manner similar to human intuitive understanding of such context and meaning.

FIG. 36 is a conceptual diagram showing further detail regarding an aspect of the system, the deep web extraction engine and examples of the type of relevant contextual information that may be gathered by the deep web extraction engine for purposes of image and video analysis.

FIG. 37 is a process flow diagram illustrating a method for recognizing, classifying, and processing the context and meaning of images and video in a manner similar to human intuitive understanding of such context and meaning.

### DETAILED DESCRIPTION OF THE INVENTION

The inventor has conceived, and reduced to practice, an image and video analysis system that is capable of recognizing, classifying, and processing the context and meaning of images and video in a manner similar to human intuitive understanding of such context and meaning

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

“Artificial intelligence” or “AI” as used herein means a computer system or component that has been programmed in such a way that it mimics some aspect or aspects of cognitive functions that humans associate with human intelligence, such as learning, problem solving, and decision-making. Examples of current AI technologies include understanding human speech, competing successfully in strategic games such as chess and Go, autonomous operation of vehicles, complex simulations, and interpretation of complex data such as images and video.

“Machine learning” as used herein is an aspect of artificial intelligence in which the computer system or component can modify its behavior or understanding without being explicitly programmed to do so. Machine learning algorithms develop models of behavior or understanding based on information fed to them as training sets, and can modify those models based on new incoming information. An example of a machine learning algorithm is AlphaGo, the first computer program to defeat a human world champion in the game of Go. AlphaGo was not explicitly programmed to play Go. It was fed millions of games of Go, and developed its own model of the game and strategies of play.

As used herein, “graph” is a representation of information and relationships, where each primary unit of information makes up a “node” or “vertex” of the graph and the relationship between two nodes makes up an edge of the graph. The concept of “node” as used herein can be quite general; nodes are elements of a workflow that produce data output (or other side effects to include internal data changes), and nodes may be for example (but not limited to) data stores that are queried or transformations that return the result of arbitrary operations over input data. Nodes can be further qualified by the connection of one or more descriptors or “properties” to that node. For example, given the node “James R,” name information for a person, qualifying properties might be “183 cm tall”, “DOB Aug. 13, 1965” and “speaks English”. Similar to the use of properties to further describe the information in a node, a relationship between two nodes that forms an edge can be qualified using a “label”. Thus, given a second node “Thomas G,” an edge between “James R” and “Thomas G” that indicates that the two people know each other might be labeled “knows.” When graph theory notation (Graph=(Vertices, Edges)) is applied this situation, the set of nodes are used as one parameter of the ordered pair, V and the set of 2 element edge endpoints are used as the second parameter of the ordered pair, E. When the order of the edge endpoints within the pairs of E is not significant, for example, the edge James R, Thomas G is equivalent to Thomas G, James R, the graph is designated as “undirected.” Under circumstances when a relationship flows from one node to another in one direction, for example James R is “taller” than Thomas G, the order of the endpoints is significant. Graphs with such edges are designated as “directed.” In the distributed computational graph system, transformations within transformation pipeline are represented as directed graph with each transformation comprising a node and the output messages between transformations comprising edges. Distributed computational graph stipulates the potential use of non-linear transformation pipelines which are programmatically linearized. Such linearization can result in exponential growth of resource consumption. The most sensible approach to overcome possibility is to introduce new transformation pipelines just as they are needed, creating only those that are ready to compute. Such method results in transformation graphs which are highly variable in size and node, edge composition as the system processes data streams. Those familiar with the art will realize that transformation graph may assume many shapes and sizes with a vast topography of edge relationships. The examples given were chosen for illustrative purposes only and represent a small number of the simplest of possibilities. These examples should not be taken to define the possible graphs expected as part of operation of the invention.

As used herein, “transformation” is a function performed on zero or more streams of input data which results in a single stream of output which may or may not then be used as input for another transformation. Transformations may comprise any combination of machine, human or machine-human interactions Transformations need not change data that enters them, one example of this type of transformation would be a storage transformation which would receive input and then act as a queue for that data for subsequent transformations. As implied above, a specific transformation may generate output data in the absence of input data. A time stamp serves as an example. In the invention, transformations are placed into pipelines such that the output of one transformation may serve as an input for another. These pipelines can consist of two or more transformations with the number of transformations limited only by the resources of the system. Historically, transformation pipelines have been linear with each transformation in the pipeline receiving input from one antecedent and providing output to one subsequent with no branching or iteration. Other pipeline configurations are possible. The invention is designed to permit several of these configurations including, but not limited to: linear, afferent branch, efferent branch and cyclical.

A “database” or “data storage subsystem” (these terms may be considered substantially synonymous), as used herein, is a system adapted for the long-term storage, indexing, and retrieval of data, the retrieval typically being via some sort of querying interface or language. “Database” may be used to refer to relational database management systems known in the art, but should not be considered to be limited to such systems. Many alternative database or data storage system technologies have been, and indeed are being, introduced in the art, including but not limited to distributed non-relational data storage systems such as Hadoop, column-oriented databases, in-memory databases, and the like. While various aspects may preferentially employ one or another of the various data storage subsystems available in the art (or available in the future), the invention should not be construed to be so limited, as any data storage architecture may be used according to the aspects. Similarly, while in some cases one or more particular data storage needs are described as being satisfied by separate components (for example, an expanded private capital markets database and a configuration database), these descriptions refer to functional uses of data storage systems and do not refer to their physical architecture. For instance, any group of data storage systems of databases referred to herein may be included together in a single database management system operating on a single machine, or they may be included in a single database management system operating on a cluster of machines as is known in the art. Similarly, any single database (such as an expanded private capital markets database) may be implemented on a single machine, on a set of machines using clustering technology, on several machines connected by one or more messaging systems known in the art, or in a master/slave arrangement common in the art. These examples should make clear that no particular architectural approaches to database management is preferred according to the invention, and choice of data storage technology is at the discretion of each implementer, without departing from the scope of the invention as claimed.

A “data context”, as used herein, refers to a set of arguments identifying the location of data. This could be a Rabbit queue, a .csv file in cloud-based storage, or any other such location reference except a single event or record. Activities may pass either events or data contexts to each other for processing. The nature of a pipeline allows for direct information passing between activities, and data locations or files do not need to be predetermined at pipeline start.

A “pipeline”, as used herein and interchangeably referred to as a “data pipeline” or a “processing pipeline”, refers to a set of data streaming activities and batch activities. Streaming and batch activities can be connected indiscriminately within a pipeline. Events will flow through the streaming activity actors in a reactive way. At the junction of a streaming activity to batch activity, there will exist a StreamBatchProtocol data object. This object is responsible for determining when and if the batch process is run. One or more of three possibilities can be used for processing triggers: regular timing interval, every N events, or optionally an external trigger. The events are held in a queue or similar until processing. Each batch activity may contain a “source” data context (this may be a streaming context if the upstream activities are streaming), and a “destination” data context (which is passed to the next activity). Streaming activities may have an optional “destination” streaming data context (optional meaning: caching/persistence of events vs. ephemeral), though this should not be part of the initial implementation.

### Conceptual Architecture

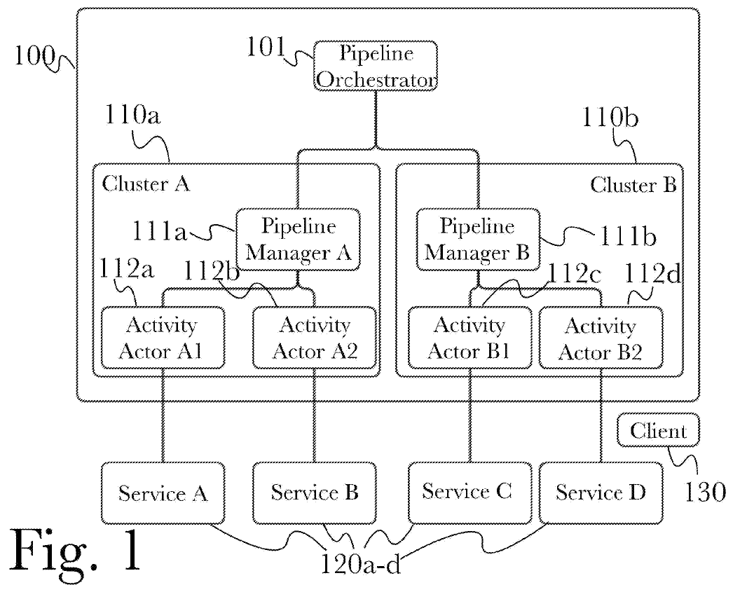

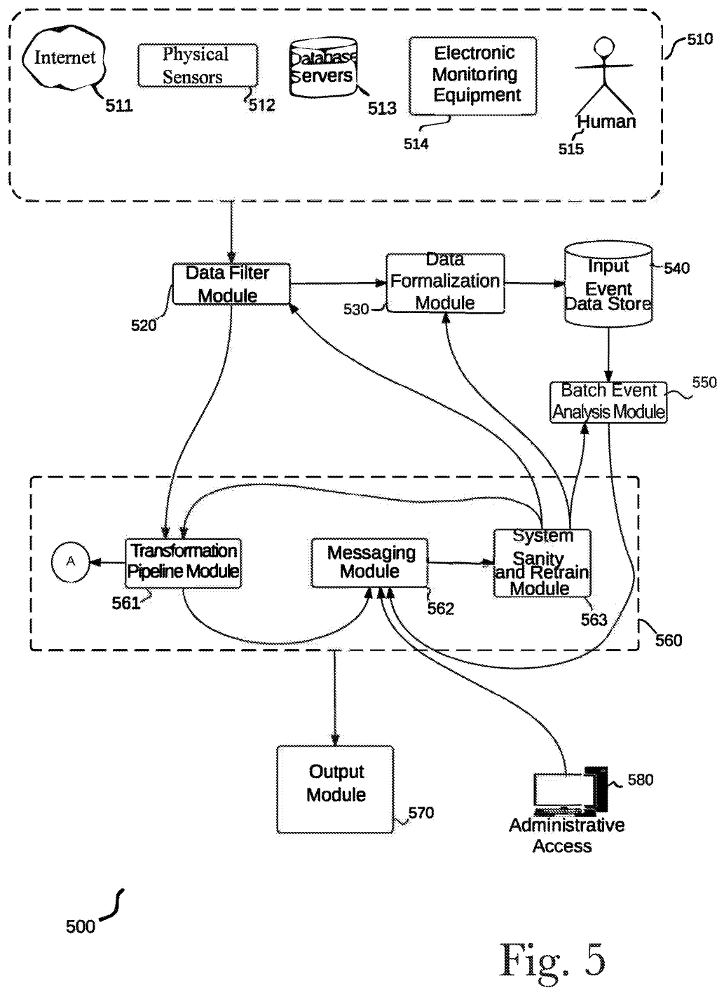

FIG. 1 is a diagram of an exemplary architecture for a system for rapid predictive analysis of very large data sets using an actor-driven distributed computational graph 100, according to one aspect. According to the aspect, a directed computational graph (DCG) 100 may comprise a pipeline orchestrator 101 that may be used to perform the functions of a transformation pipeline software module 561 as described below, with reference to FIG. 5. Pipeline orchestrator 101 may spawn a plurality of child pipeline clusters 110a-b, which may be used as dedicated workers for streamlining parallel processing. In some arrangements, an entire data processing pipeline may be passed to a child cluster 110a for handling, rather than individual processing tasks, enabling each child cluster 110a-b to handle an entire data pipeline in a dedicated fashion to maintain isolated processing of different pipelines using different cluster nodes 110a-b. Pipeline orchestrator 101 may provide a software API for starting, stopping, submitting, or saving pipelines. When a pipeline is started, pipeline orchestrator 101 may send the pipeline information to an available worker node 110a-b, for example using AKKA™ clustering. For each pipeline initialized by pipeline orchestrator 101, a reporting object with status information may be maintained. Streaming activities may report the last time an event was processed, and the number of events processed. Batch activities may report status messages as they occur. Pipeline orchestrator 101 may perform batch caching using, for example, an IGFS™ caching filesystem. This allows activities 112a-d within a pipeline 110a-b to pass data contexts to one another, with any necessary parameter configurations.

A pipeline manager 111a-b may be spawned for every new running pipeline, and may be used to send activity, status, lifecycle, and event count information to the pipeline orchestrator 101. Within a particular pipeline, a plurality of activity actors 112a-d may be created by a pipeline manager 111a-b to handle individual tasks, and provide output to data services 120a-d, optionally using a client API 130 for integration with external services or products. Data models used in a given pipeline may be determined by the specific pipeline and activities, as directed by a pipeline manager 111a-b. Each pipeline manager 111a-b controls and directs the operation of any activity actors 112a-d spawned by it. A service-specific client API 130 is separated from any particular activity actor 112a-d and may be handled by a dedicated service actor in a separate cluster. A pipeline process may need to coordinate streaming data between tasks. For this, a pipeline manager 111a-b may spawn service connectors to dynamically create TCP connections between activity instances 112a-d. Data contexts may be maintained for each individual activity 112a-d, and may be cached for provision to other activities 112a-d as needed. A data context defines how an activity accesses information, and an activity 112a-d may process data or simply forward it to a next step. Forwarding data between pipeline steps may route data through a streaming context or batch context.

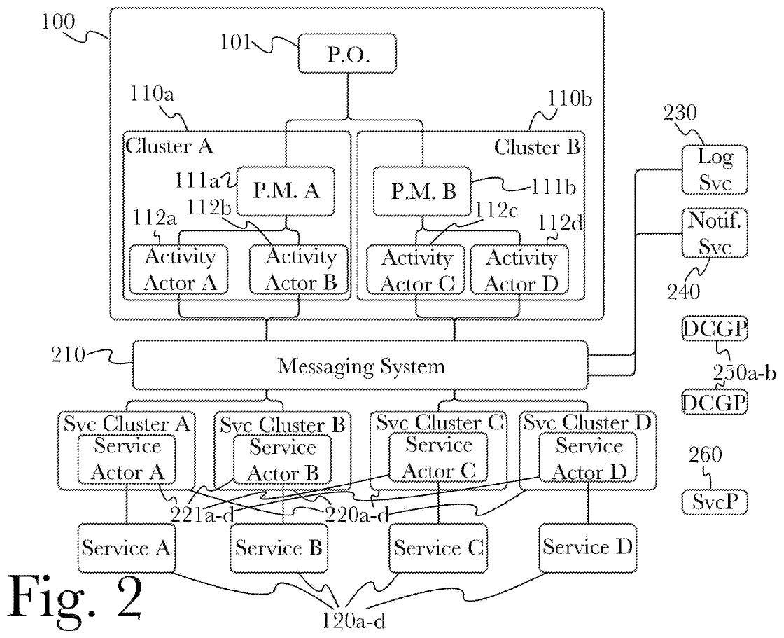

A client service cluster 130 may operate a plurality of service actors 221a-d to serve the requests of activity actors 112a-d, ideally maintaining enough service actors 221a-d to support each activity per the service type. These may also be arranged within service clusters 220a-d, in an alternate arrangement described below in FIG. 2.

FIG. 2 is a diagram of an exemplary architecture for a system for rapid predictive analysis of very large data sets using an actor-driven distributed computational graph 100, according to one aspect. According to the aspect, a DCG 100 may be used with a messaging system 210 that enables communication with any number of various services and protocols, relaying messages and translating them as needed into protocol-specific API system calls for interoperability with external systems (rather than requiring a particular protocol or service to be integrated into a DCG 100). Service actors 221a-d may be logically grouped into service clusters 220a-d, in a manner similar to the logical organization of activity actors 112a-d within clusters 110a-b in a data pipeline. A logging service 230 may be used to log and sample DCG requests and messages during operation while notification service 240 may be used to receive alerts and other notifications during operation (for example to alert on errors, which may then be diagnosed by reviewing records from logging service 230), and by being connected externally to messaging system 210, logging and notification services can be added, removed, or modified during operation without impacting DCG 100. A plurality of DCG protocols 250a-b may be used to provide structured messaging between a DCG 100 and messaging system 210, or to enable messaging system 210 to distribute DCG messages across service clusters 220a-d as shown. A service protocol 260 may be used to define service interactions so that a DCG 100 may be modified without impacting service implementations. In this manner, it can be appreciated that the overall structure of a system using an actor-driven DCG 100 operates in a modular fashion, enabling modification and substitution of various components without impacting other operations or requiring additional reconfiguration.

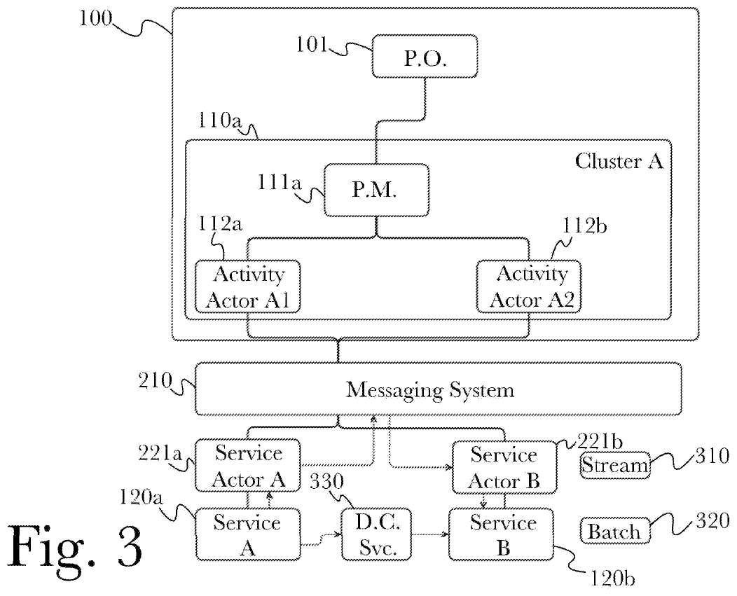

FIG. 3 is a diagram of an exemplary architecture for a system for rapid predictive analysis of very large data sets using an actor-driven distributed computational graph 100, according to one aspect. According to the aspect, a variant messaging arrangement may utilize messaging system 210 as a messaging broker using a streaming protocol 310, transmitting and receiving messages immediately using messaging system 210 as a message broker to bridge communication between service actors 221a-b as needed. Alternately, individual services 120a-b may communicate directly in a batch context 320, using a data context service 330 as a broker to batch-process and relay messages between services 120a-b.

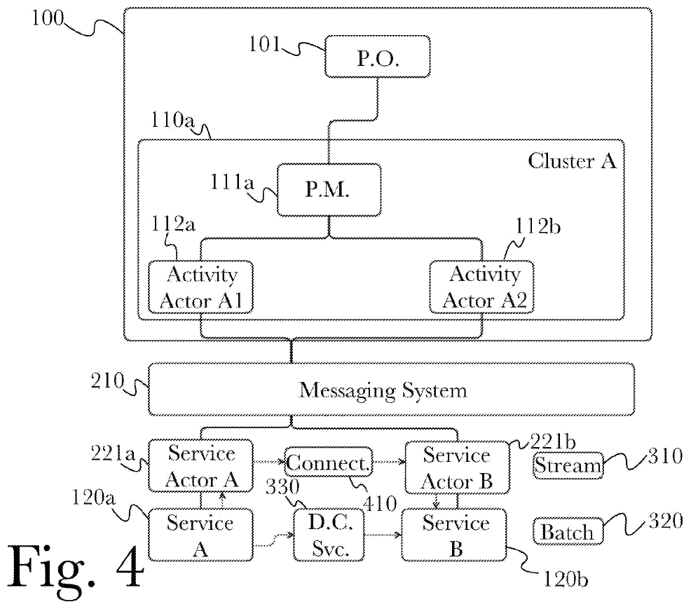

FIG. 4 is a diagram of an exemplary architecture for a system for rapid predictive analysis of very large data sets using an actor-driven distributed computational graph 100, according to one aspect. According to the aspect, a variant messaging arrangement may utilize a service connector 410 as a central message broker between a plurality of service actors 221a-b, bridging messages in a streaming context 310 while a data context service 330 continues to provide direct peer-to-peer messaging between individual services 120a-b in a batch context 320.

It should be appreciated that various combinations and arrangements of the system variants described above (referring to FIGS. 1-4) may be possible, for example using one particular messaging arrangement for one data pipeline directed by a pipeline manager 111a-b, while another pipeline may utilize a different messaging arrangement (or may not utilize messaging at all). In this manner, a single DCG 100 and pipeline orchestrator 101 may operate individual pipelines in the manner that is most suited to their particular needs, with dynamic arrangements being made possible through design modularity as described above in FIG. 2.

FIG. 5 is a block diagram of an exemplary architecture for a system 500 for predictive analysis of very large data sets using a distributed computational graph. According to the aspect, streaming input feeds 510 may be a variety of data sources which may include but are not limited to the internet 511, arrays of physical sensors 512, database servers 513, electronic monitoring equipment 514 and direct human interaction 515 ranging from a relatively few number of participants to a large crowd sourcing campaign. Streaming data from any combinations of listed sources and those not listed may also be expected to occur as part of the operation of the invention as the number of streaming input sources is not limited by the design. All incoming streaming data may be passed through a data filter software module 520 to remove information that has been damaged in transit, is misconfigured, or is malformed in some way that precludes use. Many of the filter parameters may be expected to be preset prior to operation, however, design of the invention makes provision for the behavior of the filter software module 520 to be changed as progression of analysis requires through the automation of the system sanity and retrain software module 563 which may serve to optimize system operation and analysis function. The data stream may also be split into two identical substreams at the data filter software module 520 with one substream being fed into a streaming analysis pathway that includes the transformation pipeline software module 561 of the distributed computational graph 560. The other substream may be fed to data formalization software module 530 as part of the batch analysis pathway. The data formalization module 530 formats the data stream entering the batch analysis pathway of the invention into data records to be stored by the input event data store 540. The input event data store 540 can be a database of any architectural type known to those knowledgeable in the art, but based upon the quantity of the data the data store module would be expected to store and retrieve, options using highly distributed storage and map reduce query protocols, of which Hadoop is one, but not the only example, may be generally preferable to relational database schema.

Analysis of data from the input event data store may be performed by the batch event analysis software module 550. This module may be used to analyze the data in the input event data store for temporal information such as trends, previous occurrences of the progression of a set of events, with outcome, the occurrence of a single specific event with all events recorded before and after whether deemed relevant at the time or not, and presence of a particular event with all documented possible causative and remedial elements, including best guess probability information. Those knowledgeable in the art will recognize that while examples here focus on having stores of information pertaining to time, the use of the invention is not limited to such contexts as there are other fields where having a store of existing data would be critical to predictive analysis of streaming data 561. The search parameters used by the batch event analysis software module 550 are preset by those conducting the analysis at the beginning of the process, however, as the search matures and results are gleaned from the streaming data during transformation pipeline software module 561 operation, providing the system more timely event progress details, the system sanity and retrain software module 563 may automatically update the batch analysis parameters 550. Alternately, findings outside the system may precipitate the authors of the analysis to tune the batch analysis parameters administratively from outside the system 570, 562, 563. The real-time data analysis core 560 of the invention should be considered made up of a transformation pipeline software module 561, messaging module 562 and system sanity and retrain software module 563. The messaging module 562 has connections from both the batch and the streaming data analysis pathways and serves as a conduit for operational as well as result information between those two parts of the invention. The message module also receives messages from those administering analyses 580. Messages aggregated by the messaging module 562 may then be sent to system sanity and retrain software module 563 as appropriate. Several of the functions of the system sanity and retrain software module have already been disclosed. Briefly, this is software that may be used to monitor the progress of streaming data analysis optimizing coordination between streaming and batch analysis pathways by modifying or “retraining” the operation of the data filter software module 520, data formalization software module 530 and batch event analysis software module 540 and the transformation pipeline module 550 of the streaming pathway when the specifics of the search may change due to results produced during streaming analysis. System sanity and retrain module 563 may also monitor for data searches or transformations that are processing slowly or may have hung and for results that are outside established data stability boundaries so that actions can be implemented to resolve the issue. While the system sanity and retrain software module 563 may be designed to act autonomously and employs computer learning algorithms, according to some arrangements status updates may be made by administrators or potentially direct changes to operational parameters by such, according to the aspect.

Streaming data entering from the outside data feeds 510 through the data filter software module 520 may be analyzed in real time within the transformation pipeline software module 561. Within a transformation pipeline, a set of functions tailored to the analysis being run are applied to the input data stream. According to the aspect, functions may be applied in a linear, directed path or in more complex configurations. Functions may be modified over time during an analysis by the system sanity and retrain software module 563 and the results of the transformation pipeline, impacted by the results of batch analysis are then output in the format stipulated by the authors of the analysis which may be human readable printout, an alarm, machine readable information destined for another system or any of a plurality of other forms known to those in the art.

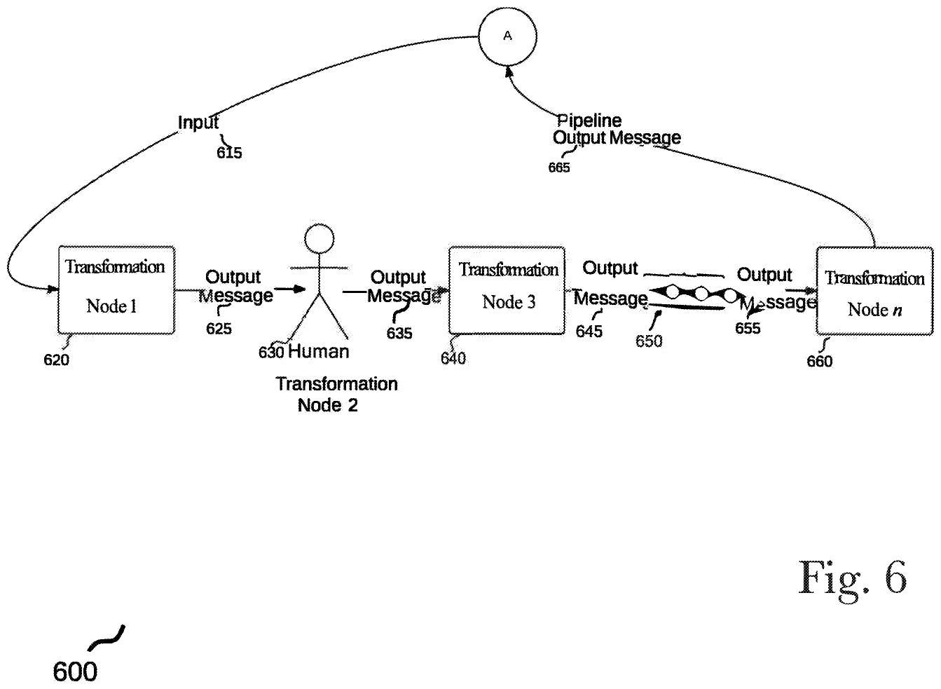

FIG. 6 is a block diagram of a preferred architecture for a transformation pipeline within a system for predictive analysis of very large data sets using distributed computational graph 600. According to the aspect, streaming input from the data filter software module 520, 615 serves as input to the first transformation node 620 of the transformation pipeline. Transformation node's function is performed on input data stream and transformed output message 625 is sent to transformation node 2 630. The progression of transformation nodes 620, 630, 640, 650, 660 and associated output messages from each node 625, 635, 645, 655, 665 is linear in configuration this is the simplest arrangement and, as previously noted, represents the current state of the art. While transformation nodes are described according to various aspects as uniform shape (referring to FIGS. 6-9), such uniformity is used for presentation simplicity and clarity and does not reflect necessary operational similarity between transformations within the pipeline. It should be appreciated that one knowledgeable in the field will realize that certain transformations in a pipeline may be entirely self-contained; certain transformations may involve direct human interaction 630, such as selection via dial or dials, positioning of switch or switches, or parameters set on control display, all of which may change during analysis; other transformations may require external aggregation or correlation services or may rely on remote procedure calls to synchronous or asynchronous analysis engines as might occur in simulations among a plurality of other possibilities. Further according to the aspect, individual transformation nodes in one pipeline may represent function of another transformation pipeline. It should be appreciated that the node length of transformation pipelines depicted in no way confines the transformation pipelines employed by the invention to an arbitrary maximum length 640, 650, 660 as, being distributed, the number of transformations would be limited by the resources made available to each implementation of the invention. It should be further appreciated that there need be no limits on transform pipeline length. Output of the last transformation node and by extension, the transform pipeline 660 may be sent back to messaging software module 562 for predetermined action.

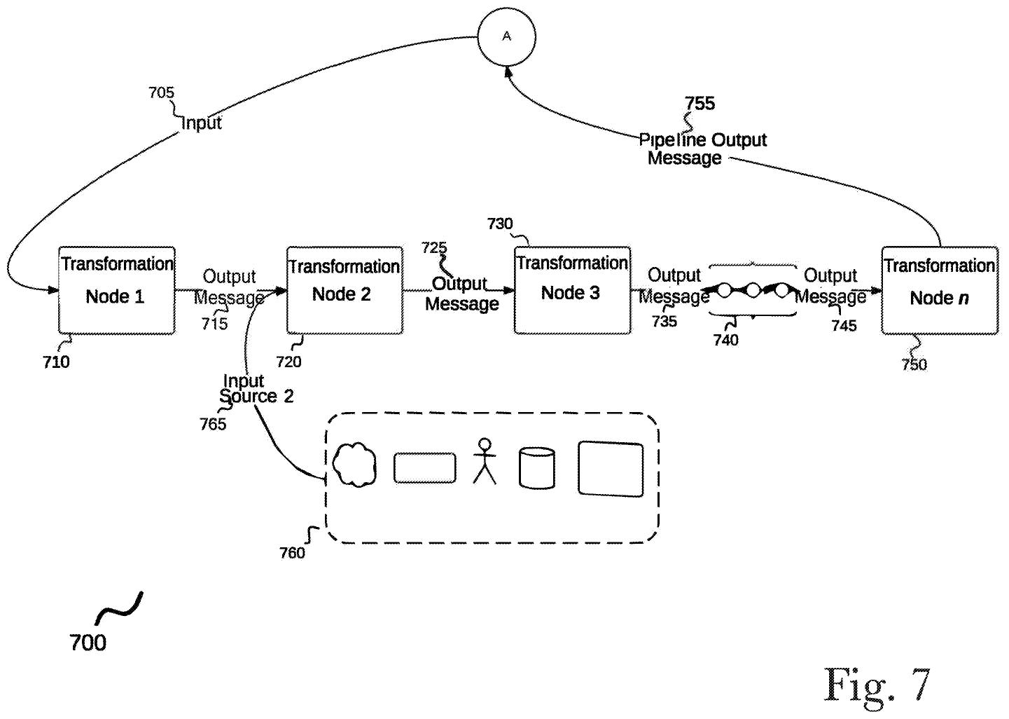

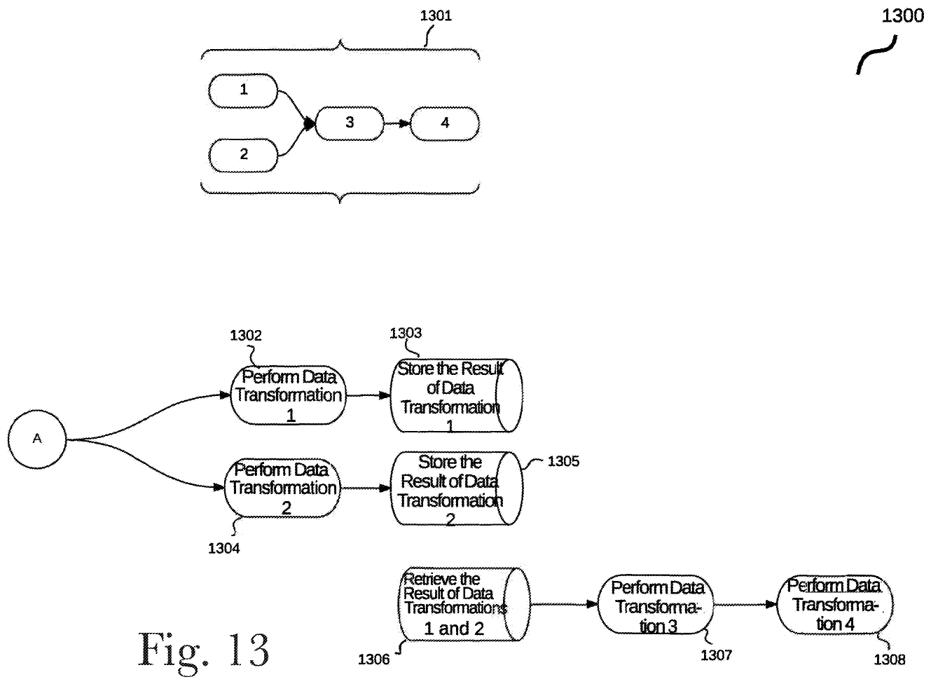

FIG. 7 is a block diagram of another preferred architecture for a transformation pipeline within a system for predictive analysis of very large data sets using distributed computational graph 700. According to the aspect, streaming input from a data filter software module 520, 705 serves as input to the first transformation node 710 of the transformation pipeline. Each transformation node's function 710, 720, 730, 740, 750 is performed on input data stream and transformed output message 715, 725, 735, 745, 755, 765 is sent to the next step. In this aspect, transformation node 2 720 has a second input stream 760. The specific source of this input is inconsequential to the operation of the invention and could be another transformation pipeline software module, a data store, human interaction, physical sensors, monitoring equipment for other electronic systems or a stream from the internet as from a crowdsourcing campaign, just to name a few possibilities 760. Functional integration of a second input stream into one transformation node requires the two input stream events be serialized. The invention performs this serialization using a decomposable transformation software module (not shown), the function of which is described below, referring to FIG. 13. While transformation nodes are described according to various aspects as uniform shape (referring to FIGS. 6-9), such uniformity is used for presentation simplicity and clarity and does not reflect necessary operational similarity between transformations within the pipeline. It should be appreciated that one knowledgeable in the field will realize that certain transformations in a pipeline may be entirely self-contained; certain transformations may involve direct human interaction 630, such as selection via dial or dials, positioning of switch or switches, or parameters set on control display, all of which may change during analysis; other transformations may require external aggregation or correlation services or may rely on remote procedure calls to synchronous or asynchronous analysis engines as might occur in simulations among a plurality of other possibilities. For example, engines may be singletons (composed of a single activity or transformation). Furthermore, leveraging the architecture in this way allows for versioning and functional decomposition (i.e. embedding entire saved workflows as single nodes in other workflows). Further according to the aspect, individual transformation nodes in one pipeline may represent function of another transformation pipeline. It should be appreciated that the node length of transformation pipelines depicted in no way confines the transformation pipelines employed by the invention to an arbitrary maximum length 710, 720, 730, 740, 750, as, being distributed, the number of transformations would be limited by the resources made available to each implementation of the invention. It should be further appreciated that there need be no limits on transform pipeline length. Output of the last transformation node and by extension, the transform pipeline, 750 may be sent back to messaging software module 562 for pre-decided action.

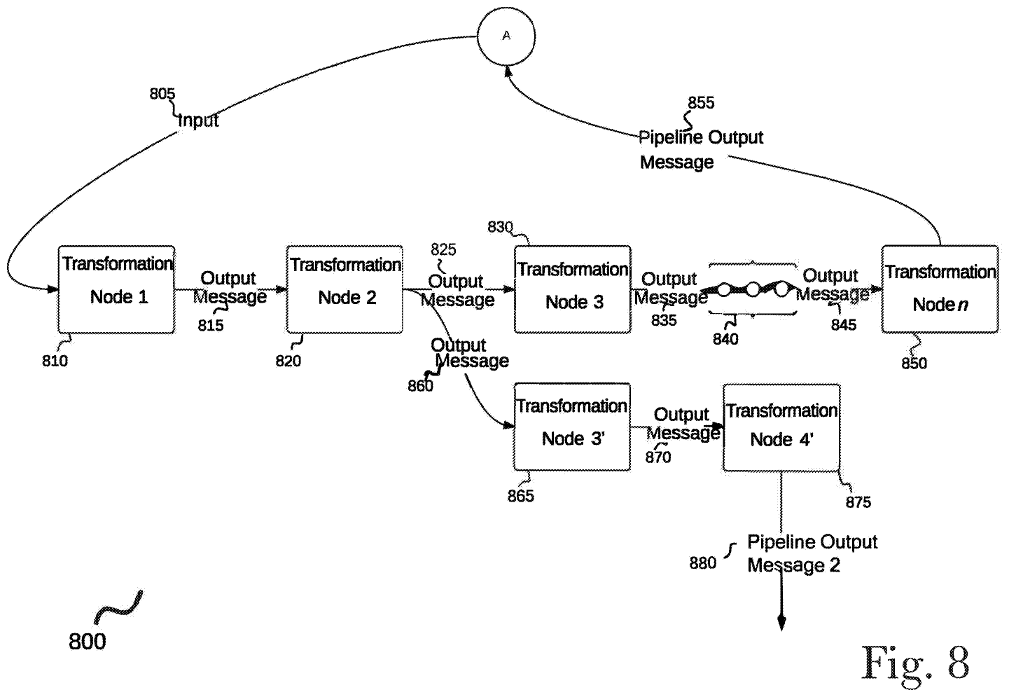

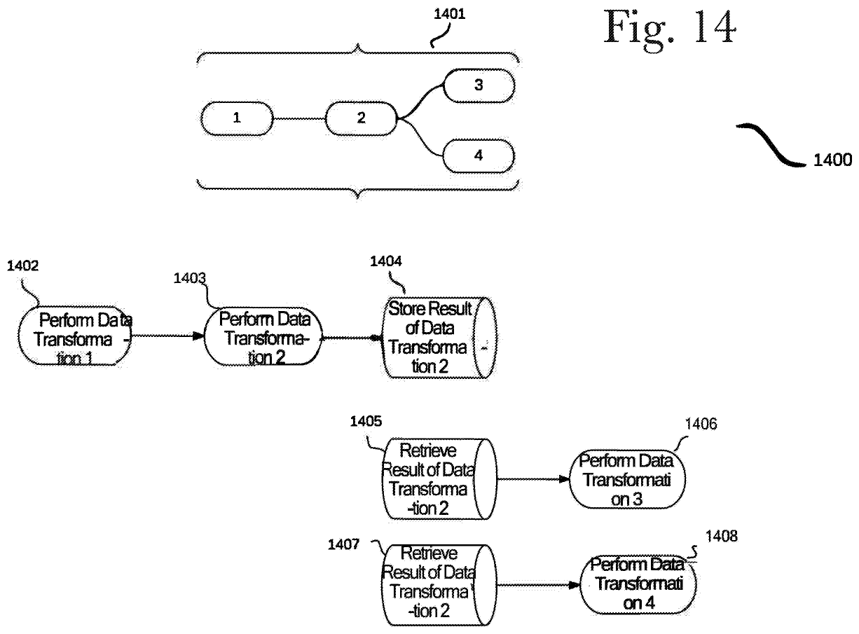

FIG. 8 is a block diagram of another preferred architecture for a transformation pipeline within a system for predictive analysis of very large data sets using distributed computational graph 700. According to the aspect, streaming input from a data filter software module 520, 805 serves as input to the first transformation node 810 of the transformation pipeline. Transformation node's function is performed on input data stream and transformed output message 815 is sent to transformation node 2 820. In this aspect, transformation node 2 820 sends its output stream 825, 860 to two transformation pipelines 830, 840, 850; 865, 875. This allows the same data stream to undergo two disparate, possibly completely unrelated, analyses 825, 835, 845, 855; 860, 870, 880 without having to duplicate the infrastructure of the initial transform manipulations, greatly increasing the expressivity of the invention over current transform pipelines. Functional integration of a second output stream from one transformation node 820 requires that the two output stream events be serialized. The invention performs this serialization using a decomposable transformation software module (not shown), the function of which is described below, referring to FIG. 14. While transformation nodes are described according to various aspects as uniform shape (referring to FIGS. 6-9), such uniformity is used for presentation simplicity and clarity and does not reflect necessary operational similarity between transformations within the pipeline. It should be appreciated that one knowledgeable in the field will realize that certain transformations in pipelines, which may be entirely self-contained; certain transformations may involve direct human interaction 630, such as selection via dial or dials, positioning of switch or switches, or parameters set on control display, all of which may change during analysis; other transformations may require external aggregation or correlation services or may rely on remote procedure calls to synchronous or asynchronous analysis engines as might occur in simulations, among a plurality of other possibilities. Further according to the aspect, individual transformation nodes in one pipeline may represent function of another transformation pipeline. It should be appreciated that the node number of transformation pipelines depicted in no way confines the transformation pipelines employed by the invention to an arbitrary maximum length 810, 820, 830, 840, 850; 865, 875 as, being distributed, the number of transformations would be limited by the resources made available to each implementation of the invention. Further according to the aspect, there need be no limits on transform pipeline length. Output of the last transformation node and by extension, the transform pipeline 850 may be sent back to messaging software module 562 for contemporary enabled action.

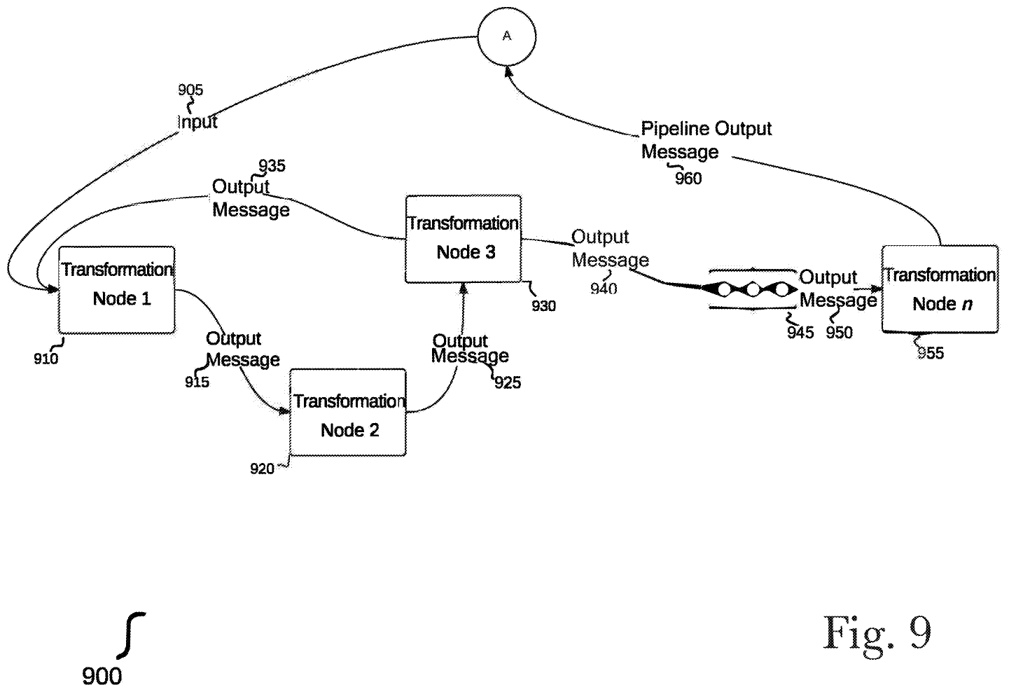

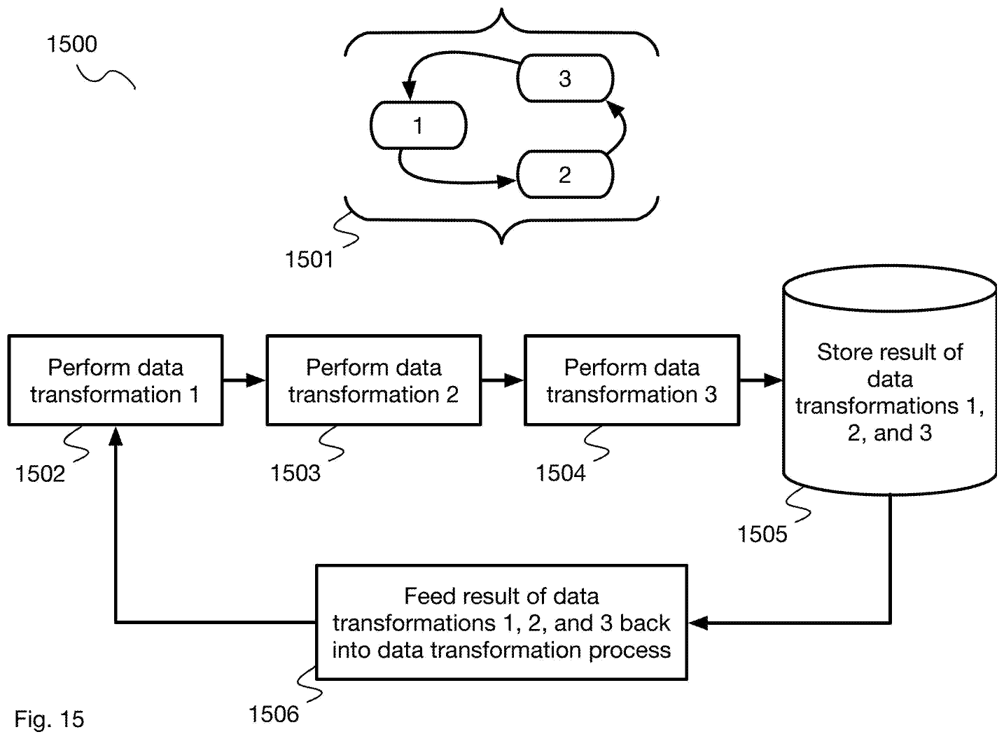

FIG. 9 is a block diagram of another preferred architecture for a transformation pipeline within a system for predictive analysis of very large data sets using distributed computational graph 700. According to the aspect, streaming input from a data filter software module 520, 905 serves as input to the first transformation node 910 of the transformation pipeline. Transformation node's function may be performed on an input data stream and transformed output message 915 may then be sent to transformation node 2 920. Likewise, once the data stream is acted upon by transformation node 2 920, its output is sent to transformation node 3 930 using its output message 925 In this aspect, transformation node 3 930 sends its output stream back 935 to transform node 1 910 forming a cyclical relationship between transformation nodes 1 910, transformation node 2 920 and transformation node 3 930. Upon the achievement of some gateway result, the output of cyclical pipeline activity may be sent to downstream transformation nodes within the pipeline 940, 945. The presence of a generalized cyclical pathway construct allows the invention to be used to solve complex iterative problems with large data sets involved, expanding ability to rapidly retrieve conclusions for complicated issues. Functional creation of a cyclical transformation pipeline requires that each cycle be serialized. The invention performs this serialization using a decomposable transformation software module (not shown), the function of which is described below, referring to FIG. 15. While transformation nodes are described according to various aspects as uniform shape (referring to FIGS. 6-9), such uniformity is used for presentation simplicity and clarity and does not reflect necessary operational similarity between transformations within the pipeline. It should be appreciated that one knowledgeable in the field will appreciate that certain transformations in pipelines, may be entirely self-contained; certain transformations may involve direct human interaction 630, such as selection via dial or dials, positioning of switch or switches, or parameters set on control display, all of which may change during analysis; still other transformations may require external aggregation or correlation services or may rely on remote procedure calls to synchronous or asynchronous analysis engines as might occur in simulations, among a plurality of other possibilities. Further according to the aspect, individual transformation nodes in one pipeline may represent the cumulative function of another transformation pipeline. It should be appreciated that the node number of transformation pipelines depicted in no way confines the transformation pipelines employed by the invention to an arbitrary maximum length 910, 920, 930, 940, 950, 960; 965, 975 as, being distributed, the number of transformations would be limited by the resources made available to each implementation of the invention. It should be further appreciated that there need be no limits on transform pipeline length. Output of the last transformation node and by extension, the transform pipeline 955 may be sent back to messaging software module 562 for concomitant enabled action.

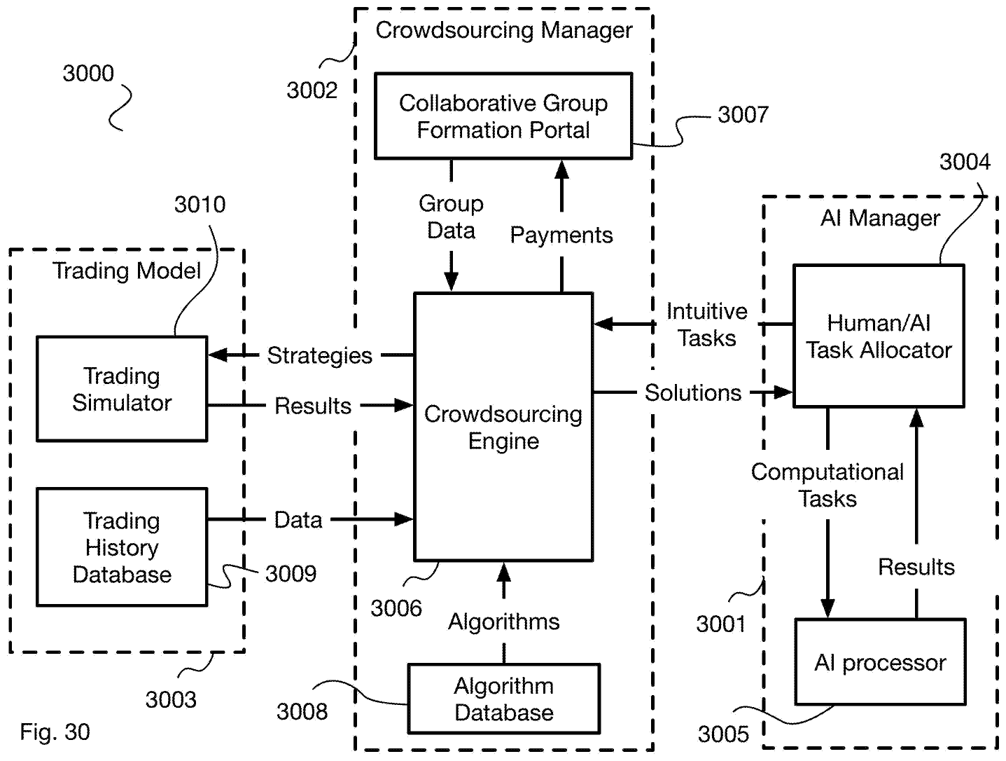

FIG. 30 is a block diagram showing an exemplary representation of a collaborative algorithm development, deployment, and tuning platform as applied to the field of quantitative securities trading 3000. The platform consists of three overall components, an AI manager 3001, a crowdsourcing manager 3002, and a trading model 3003. As problem sets are received by the platform, they are directed to the human/AI task allocator 3004, which analyzes each problem set for components of the problem set that are primarily intuitive in nature or primarily computational in nature. The human/AI task allocator 3004 sends the computationally intensive tasks to an AI processor 3005, which performs the necessary computations and makes decisions based on its internal machine learning algorithms, and returns the results to the human/AI task allocator 3004. The human/AI task allocator 3004 sends intuitive tasks to the crowdsourcing engine 3006 within the crowdsourcing manager 3002. The crowdsourcing manager 3002 coordinates the entire process of crowdsourced development of algorithms and strategies. Within the crowdsourcing manager 3002, individuals register for access and optionally form groups in the collaborative group formation portal 3007, which sends the individual or group data to the crowdsourcing engine 3006. The crowdsourcing engine 3006 receives the group data from the collaborative group formation portal 3007, tasks from the human/AI task allocator 3004, and allows individuals or groups to choose which tasks they would like to complete. Once an individual or group selects a task to complete, the crowdsourcing manager 3006 provides access to the algorithm database 3008 for development of algorithms and strategies for optimal completion of the tasks. The individual or group further has access to a model of a particular field of endeavor which, in this embodiment, is a quantitative trading model 3009, consisting of a trading history database 3009 and a trading simulator 3010. The trading model 3003 is used by the individual or group to test its algorithms and strategies before sending the algorithms or strategies as task solutions back to the human/AI task allocator 3004. The human/AI task allocator 3004 combines the results from the AI processor 3005 and the solutions from the crowdsourcing engine 3006 into an overall solution to the problem set.

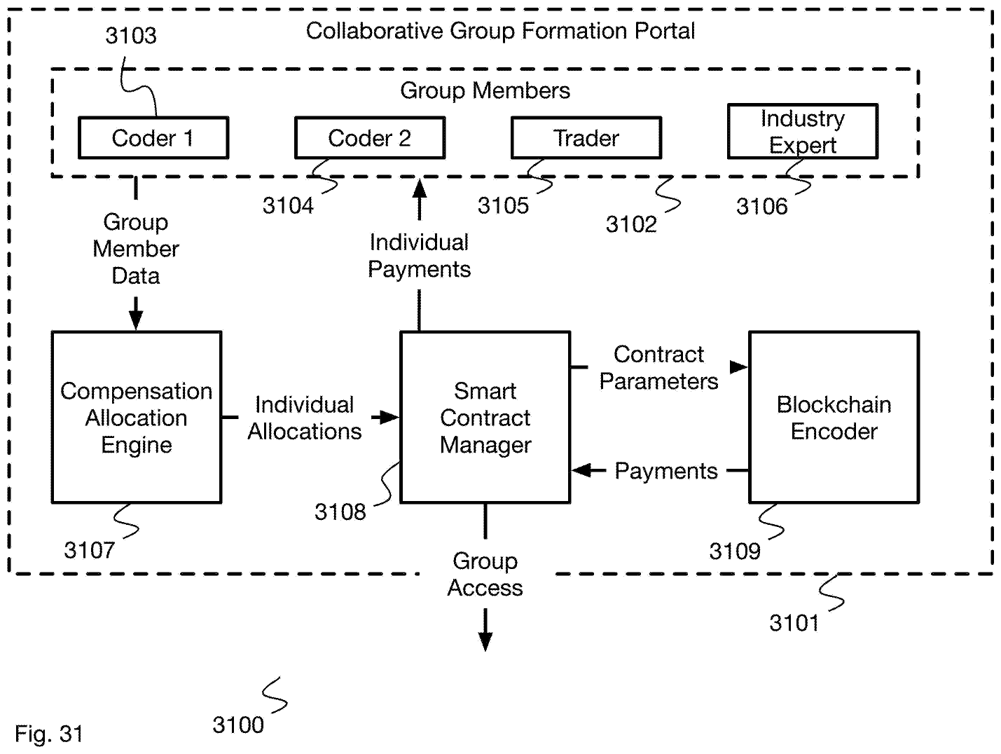

FIG. 31 is a block diagram showing additional detail regarding the collaborative group formation portal aspect 3100 of a collaborative algorithm development, deployment, and tuning platform. The collaborative group formation portal 3101 is where individuals register for access to the platform and optionally form groups for development of algorithms and strategies for solving problem sets. In this example, a group 3102 has been formed consisting of two programmers, coder 1 3103, coder 2 3104, a securities trader 3105, and an expert 3106 in the industry in which the trading will occur. Each of these individuals bring certain strengths and abilities to the group which are captured during the registration process and updated automatically as the group's work product is used by others. The group member data is fed to the compensation allocation engine 3107, which allocates compensation among the group members based on a predictive calculation of that member's expected contributions in developing algorithms and strategies. The compensation allocation engine 3107 sends its allocations for each individual member to the smart contract manager 3108, which creates contract parameters and sends them to a blockchain encoder 3109 or other secure mechanism for ensuring payment for completed transactions. As payments are received from the blockchain encoder 3109, the smart contract manager 3108 transfers the individual payments to the respective group members 3102. Once a group is formed, the compensation allocation has been determined, and the smart contract has been created, the collaborative group formation portal 3101 provides the group with access to the rest of the platform for development and testing.

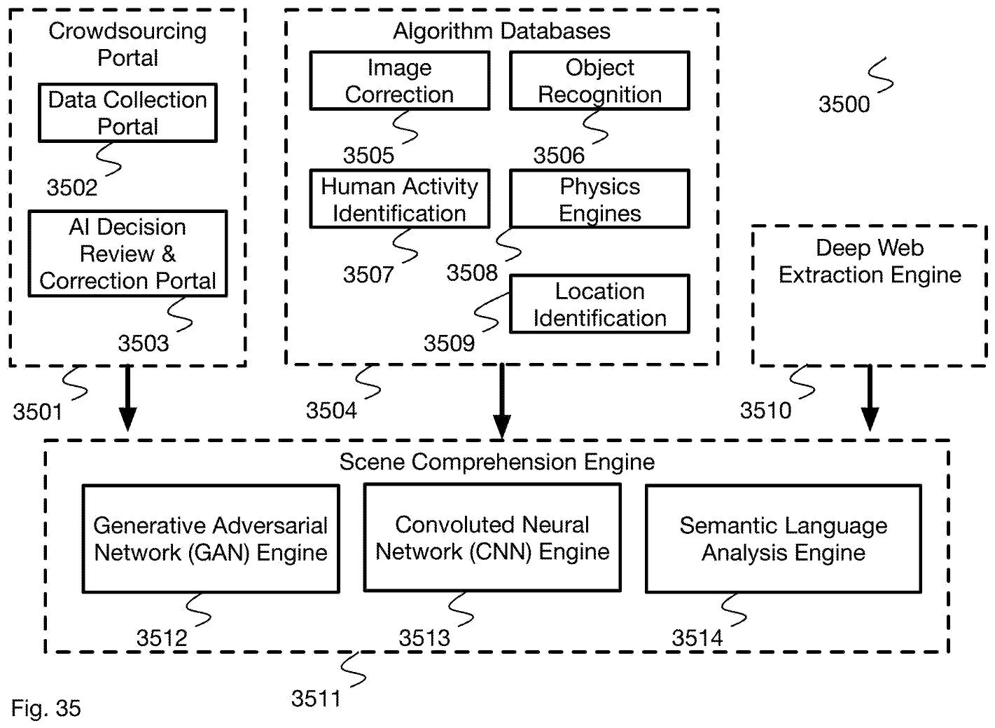

FIG. 35 is a block diagram showing an exemplary representation 3500 of a system for recognizing, classifying, and processing the context and meaning of images and video in a manner similar to human intuitive understanding of such context and meaning. The system is comprised of a crowdsourcing portal 3501, an algorithm database 3504, and a deep web extraction engine 3510, which provide inputs to a scene comprehension engine 3511. Images and video for analysis would come from a multiplicity of sources, including at least the crowdsourcing portal 3501. Through the crowdsourcing portal 3501, individuals and groups would be enabled to submit the images and video they generate from a multiplicity of devices through a data collection portal 3502 for analysis. The crowdsourcing portal 3501 would allow for inputs from a variety of mobile and fixed devices such as smart phones, vehicle mounted cameras, drones, robots, stationary cameras, etc. It would also allow for human review and correction of the context and meaning generated by the system through an AI decision review and correction portal 3503. Contributions could be either compensated monetarily or through non-monetary incentives, depending on the structure of the platform. The algorithm database 3504 would comprise specialized algorithms for image and video processing, including, but not limited to, image correction 3505, object recognition and identification 3506 (buildings, vehicles, plants/animals, people, etc.), human activity and role recognition and identification 3507 (sports, commuting, occupations, etc.), physics engines 3508, location recognition and identification 3509, and the like. The deep web extraction engine 3510 would gather real world information from the internet that is relevant to analyzing context and meaning. The scene comprehension engine 3511 would be comprised of a variety of machine learning algorithms (for example, generative adversarial networks (GANs) 3512, convoluted neural networks (CNNs) 3513, and semantic language analysis engines 3514) that would analyze the images and video obtained through the crowdsourcing engine 3511, using the algorithms contained in the algorithm database 3504 and the real world information provided by the deep web extraction engine 3510. The result would be a computer-generated classification of the context and meaning of the images and video similar to the manner in which humans would understand such context and meaning, and would be usable for a wide variety of applications not currently possible with existing technology.

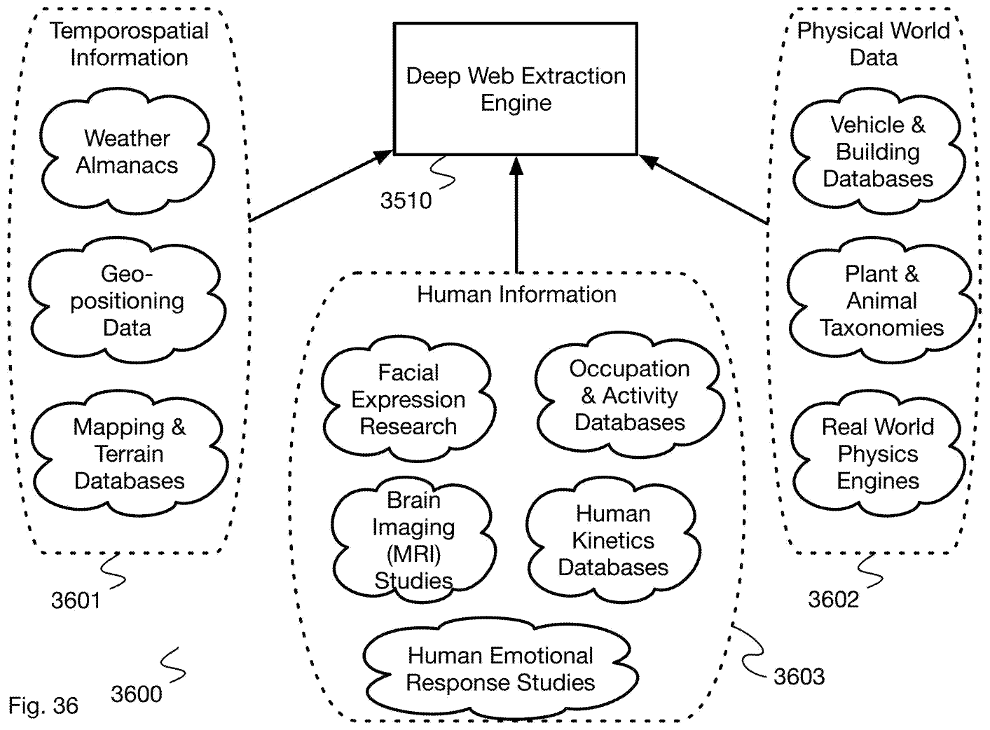

FIG. 36 is a diagram showing further detail regarding an aspect 3600 of the system, the previously disclosed deep web extraction engine 3510 and examples of the type of relevant contextual information that may be gathered by the deep web extraction engine 3510 for purposes of image and video analysis. The deep web extraction engine 3510 would gather real world information from the internet that is relevant to analyzing context and meaning, such as temporospatial information 3601 (weather, geopositioning, maps and terrain, etc.), physical world data 3602 (vehicle and building information, plant and animal taxonomies, physics models, etc.), and human information 3603 (facial expression information, occupation and activity information, brain imaging studies, human kinetics studies, and human emotional response studies, etc.). This gathered information would be fed into the previously disclosed scene comprehension engine 3511.

### Description of Method Aspects

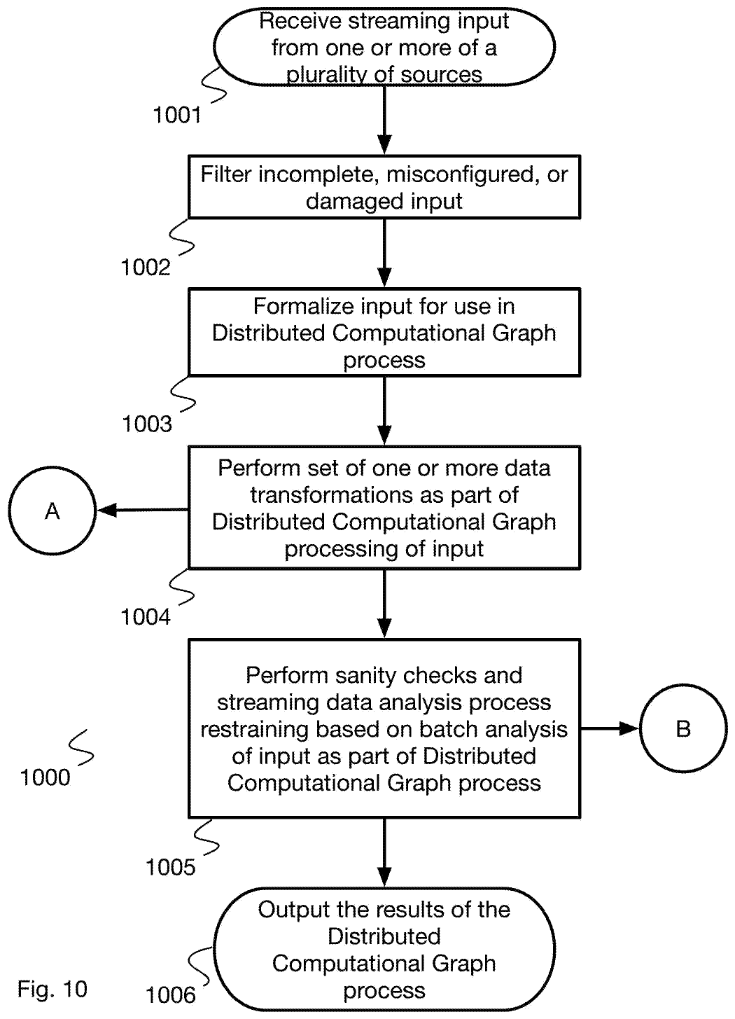

FIG. 10 is a process flow diagram of a method 1000 for predictive analysis of very large data sets using the distributed computational graph. One or more streams of data from a plurality of sources, which includes, but is in no way not limited to, a number of physical sensors, web-based questionnaires and surveys, monitoring of electronic infrastructure, crowd sourcing campaigns, and direct human interaction, may be received by system 1001. The received stream is filtered 1002 to exclude data that has been corrupted, data that is incomplete or misconfigured and therefore unusable, data that may be intact but nonsensical within the context of the analyses being run, as well as a plurality of predetermined analysis related and unrelated criteria set by the authors. Filtered data may be split into two identical streams at this point (second stream not depicted for simplicity), wherein one substream may be sent for batch processing 1600 while another substream may be formalized 1003 for transformation pipeline analysis 1004, 561, 600, 700, 800, 900 and retraining 1005. Data formalization for transformation pipeline analysis acts to reformat the stream data for optimal, reliable use during analysis. Reformatting might entail, but is not limited to: setting data field order, standardizing measurement units if choices are given, splitting complex information into multiple simpler fields, and stripping unwanted characters, again, just to name a few simple examples. The formalized data stream may be subjected to one or more transformations. Each transformation acts as a function on the data and may or may not change the data. Within the invention, transformations working on the same data stream where the output of one transformation acts as the input to the next are represented as transformation pipelines. While the great majority of transformations in transformation pipelines receive a single stream of input, modify the data within the stream in some way and then pass the modified data as output to the next transformation in the pipeline, the invention does not require these characteristics. According to the aspect, individual transformations can receive input of expected form from more than one source 1300 or receive no input at all as would a transformation acting as a timestamp. According to the aspect, individual transformations, may not modify the data as would be encountered with a data store acting as a queue for downstream transformations 1303, 1305, 1405, 1407,1505. According to the aspect, individual transformations may provide output to more than one downstream transformations 1400. This ability lends itself to simulations where multiple possible choices might be made at a single step of a procedure all of which need to be analyzed. While only a single, simple use case has been offered for each example, in each case, that example was chosen for simplicity of description from a plurality of possibilities, the examples given should not be considered to limit the invention to only simplistic applications. Last, according to the invention, transformations in a transformation pipeline backbone may form a linear, a quasi-linear arrangement or may be cyclical 1500, where the output of one of the internal transformations serves as the input of one of its antecedents allowing recursive analysis to be run. The result of transformation pipeline analysis may then be modified by results from batch analysis of the data stream 1600 and output 1006 in format predesigned by the authors of the analysis with could be human readable summary printout, human readable instruction printout, human-readable raw printout, data store, or machine encoded information of any format known to the art to be used in further automated analysis or action schema.

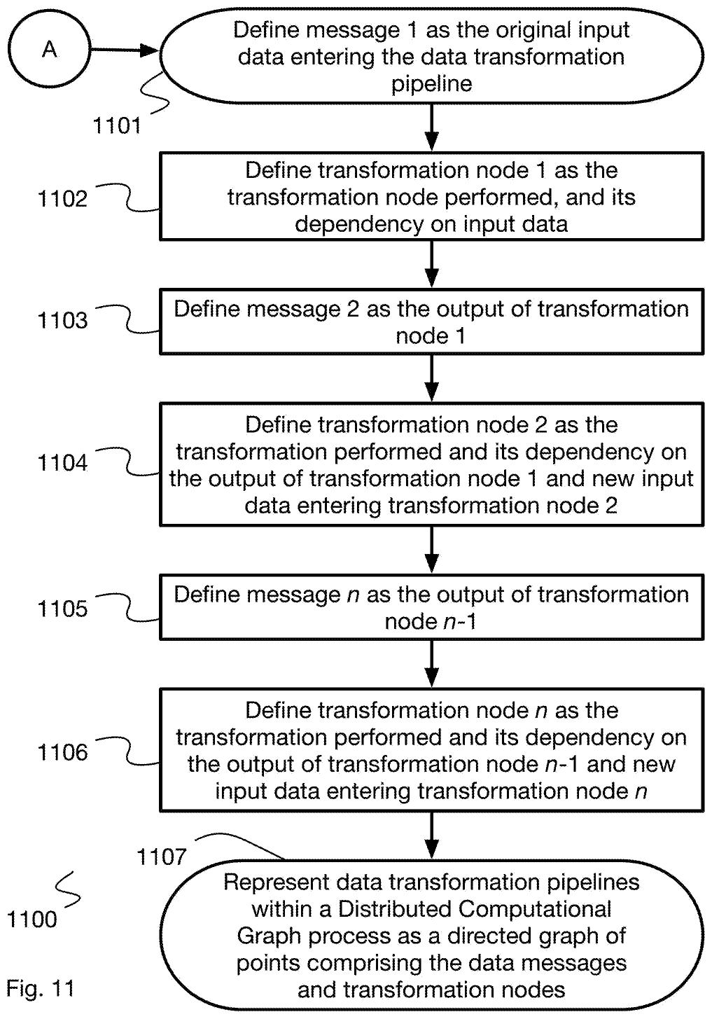

FIG. 11 is a process flow diagram of a method 1100 for an aspect of modeling the transformation pipeline module 561 of the invention as a directed graph using graph theory. According to the aspect, the individual transformations 1102, 1104, 1106 of the transformation pipeline t₁ . . . tₙ such that each tᵢ T are represented as graph nodes. Transformations belonging to T are discrete transformations over individual datasets dᵢ, consistent with classical functions. As such, each individual transformation tⱼ, receives a set of inputs and produces a single output. The input of an individual transformation tᵢ, is defined with the function in: tᵢd₁ . . . dₖ such that in(tᵢ)={d₁ . . . dₖ) and describes a transformation with k inputs. Similarly, the output of an individual transformation is defined as the function out: tᵢ[ld₁] to describe transformations that produce a single output (usable by other transformations). A dependency function can now be defined such that dep(tₐ,t_{b}) out(tₐ)in(t_{b}) The messages carrying the data stream through the transformation pipeline 1101, 1103, 1105 make up the graph edges. Using the above definitions, then, a transformation pipeline within the invention can be defined as G=(V,E) where message(t₁,t₂ . . . t(ₙ₋₁),tₙ)V and all transformations t₁ . . . tₙ and all dependencies dep(tᵢ,tⱼ)E 1107.

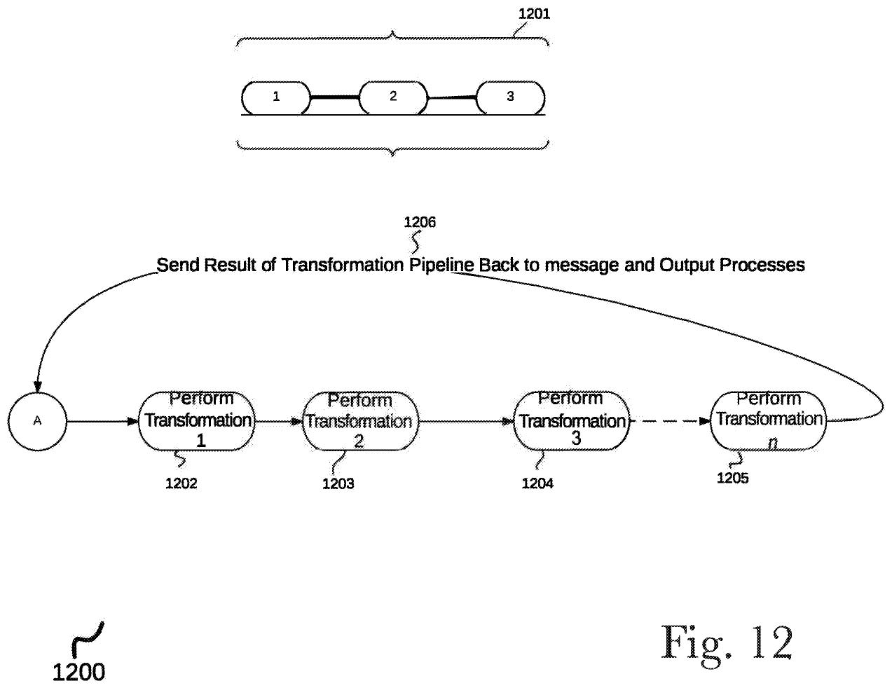

FIG. 12 is a process flow diagram of a method 1200 for one aspect of a linear transformation pipeline 1201. This is the simplest of configurations as the input stream is acted upon by the first transformation node 1202 and the remainder of the transformations within the pipeline are then performed sequentially 1202, 1203, 1204, 1205 for the entire pipeline with no introduction of new data internal to the initial node or splitting output stream prior to last node of the pipeline 1205, which then sends the results of the pipeline 1206 as output. This configuration is the current state of the art for transformation pipelines and is the most general form of these constructs. Linear transformation pipelines require no special manipulation to simplify the data pathway and are thus referred to as non-decomposable. The example depicted in this diagram was chosen to convey the configuration of a linear transformation pipeline and is the simplest form of the configuration felt to show the point. It in no way implies limitation of the invention.

FIG. 13 is a process flow diagram of a method 1300 for one aspect of a transformation pipeline where one transformation node 1307 in a transformation pipeline receives data streams from two source transformation nodes 1301. The invention handles this transformation pipeline configuration by decomposing or serializing the input events 1302-1303, 1304-1305 heavily relying on post transformation function continuation. The results of individual transformation nodes 1302, 1304 just antecedent to the destination transformation node 1306 and placed into a single specialized data storage transformation node 1303, 1305 (shown twice as process occurs twice). The combined results then retrieved from the data store 1306 and serve as the input stream for the transformation node within the transformation pipeline backbone 1307, 1308. The example depicted in this diagram was chosen to convey the configuration of transformation pipelines with individual transformation nodes that receive input from two source nodes 1302, 1304 and is the simplest form of the configuration felt to show the point. It in no way implies limitation of the invention. One knowledgeable in the art will realize the great number of permutations and topologies possible, especially as the invention places no design restrictions on the number of transformation nodes receiving input from greater than one sources or the number sources providing input to a destination node.

FIG. 14 is a process flow diagram of a method 1400 for one aspect of a transformation pipeline where one transformation node 1403 in a transformation pipeline receives input data from a transformation node 1402, and sends output data stream to two destination transformation nodes 1401, 1406, 1408 in potentially two separate transformation pipelines. The invention handles this transformation pipeline configuration by decomposing or serializing the output events 1404, 1405-1406, 1407-1408. The results of the source transformation node 1403 just antecedent to the destination transformation nodes 1406 and placed into a single specialized data storage transformation node 1404, 1405, 1407 (shown three times as storage occurs and retrieval occurs twice). The results of the antecedent transformation node may then be retrieved from a data store 1404 and serves as the input stream for the transformation nodes two downstream transformation pipeline 1406, 1408. The example depicted in this diagram was chosen to convey the configuration of transformation pipelines with individual transformation nodes that send output streams to two destination nodes 1406, 1408 and is the simplest form of the configuration felt to show the point. It in no way implies limitation of the invention. One knowledgeable in the art will realize the great number of permutations and topologies possible, especially as the invention places no design restrictions on the number of transformation nodes sending output to greater than one destination or the number destinations receiving input from a source node.

FIG. 15 is a process flow diagram of a method 1500 for one aspect of a transformation pipeline where the topology of all or part of the pipeline is cyclical 1501. In this configuration, the output stream of one transformation node 1504 acts as an input of an antecedent transformation node within the pipeline 1502 serialization or decomposition linearizes this cyclical configuration by completing the transformation of all of the nodes that make up a single cycle 1502, 1503, 1504 and then storing the result of that cycle in a data store 1505. That result of a cycle is then reintroduced to the transformation pipeline as input 1506 to the first transformation node of the cycle. As this configuration is by nature recursive, special programming to unfold the recursions was developed for the invention to accommodate it. The example depicted in this diagram was chosen to convey the configuration of transformation pipelines with individual transformation nodes that for a cyclical configuration 1501, 1502, 1503, 1504 and is the simplest form of the configuration felt to show the point. It in no way implies limitation of the invention. One knowledgeable in the art will realize the great number of permutations and topologies possible, especially as the invention places no design restrictions on the number of transformation nodes participating in a cycle nor the number of cycles in a transformation pipeline.

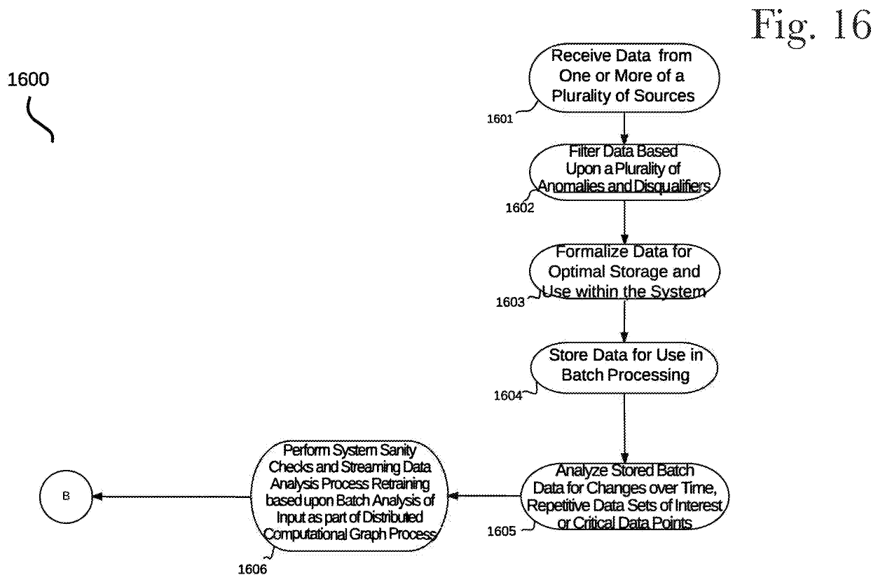

FIG. 16 is a process flow diagram of a method 1600 for one aspect of the batch data stream analysis pathway which forms part of the invention and allows streaming data to be interpreted with historic context. One or more streams of data from a plurality of sources, which includes, but is in no way not limited to, a number of physical sensors, web-based questionnaires and surveys, monitoring of electronic infrastructure, crowd sourcing campaigns, and direct human interaction, is received by the system 1601. The received stream may be filtered 1602 to exclude data that has been corrupted, data that is incomplete or misconfigured and therefore unusable, data that may be intact but nonsensical within the context of the analyses being run, as well as a plurality of predetermined analysis related and unrelated criteria set by the authors. Data formalization 1603 for batch analysis acts to reformat the stream data for optimal, reliable use during analysis. Reformatting might entail, but is not limited to: setting data field order, standardizing measurement units if choices are given, splitting complex information into multiple simpler fields, and stripping unwanted characters, again, just to name a few simple examples. The filtered and formalized stream is then added to a distributed data store 1604 due to the vast amount of information accrued over time. The invention has no dependency for specific data stores or data retrieval model. During transformation pipeline analysis of the streaming pipeline, data stored in the batch pathway store can be used to track changes in specifics of the data important to the ongoing analysis over time, repetitive data sets significant to the analysis or the occurrence of critical points of data 1605. The functions of individual transformation nodes 620 may be saved and can be edited also all nodes of a transformation pipeline 600 keep a summary or summarized view (analogous to a network routing table) of applicable parts of the overall route of the pipeline along with detailed information pertaining to adjacent two nodes. This framework information enables steps to be taken and notifications to be passed if individual transformation nodes 640 within a transformation pipeline 600 become unresponsive during analysis operations. Combinations of results from the batch pathway, partial and streaming output results from the transformation pipeline, administrative directives from the authors of the analysis as well as operational status messages from components of the distributed computational graph are used to perform system sanity checks and retraining of one or more of the modules of the system 1606. These corrections are designed to occur without administrative intervention under all but the most extreme of circumstances with deep learning capabilities present as part of the system manager and retrain module 563 responsible for this task.

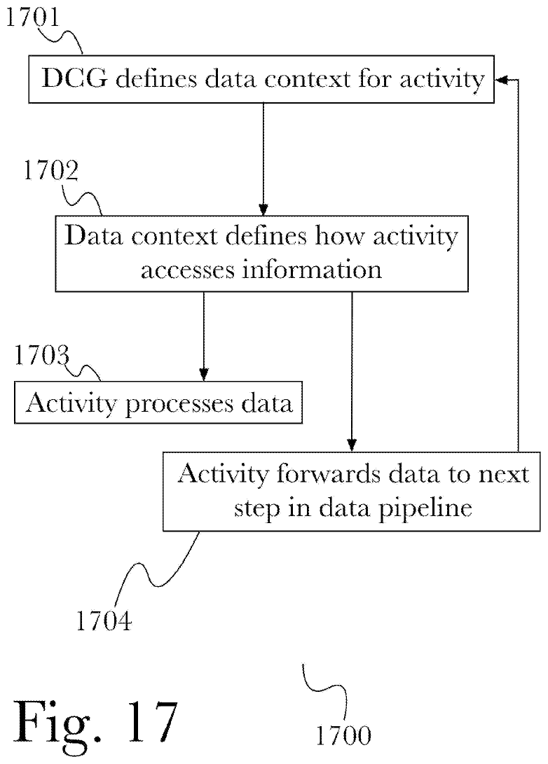

FIG. 17 is a process flow diagram for an exemplary method 1700 for rapid predictive analysis of very large data sets using an actor-driven distributed computational graph, according to one aspect. In an initial step 1701, a DCG 100 may define a plurality of data contexts for each of a plurality of actions within a data pipeline. These contexts each in turn define 1702 how their respective activities may interact with data in the pipeline. Any given activity may, based on the defined data context, either process data 1703 (generally by performing any of a number of data transformations as described previously, referring to FIG. 5), or by forwarding at least a portion of the data onward to the next step in the pipeline 1704, which may in turn be another activity with a defined context determining how it handles the forwarded data. In this manner, operation may continue in a directed fashion wherein each agent has clearly-defined capabilities and data progresses toward the end of the pipeline according to the established definitions.

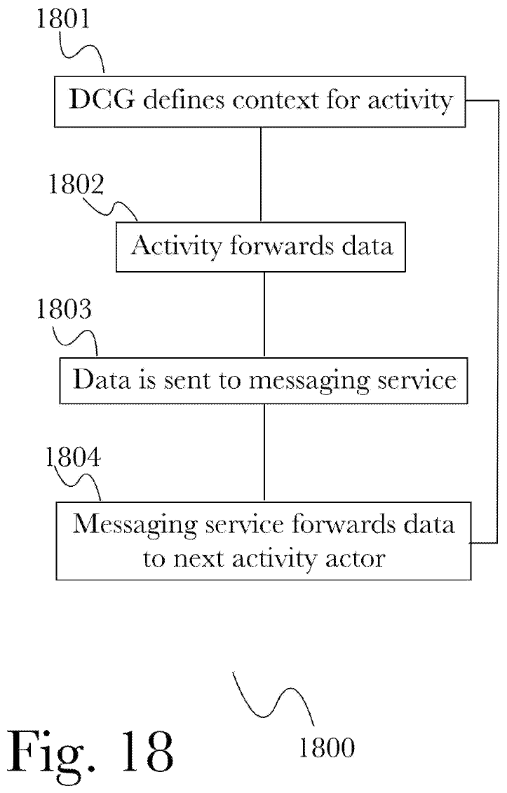

FIG. 18 is a process flow diagram for an exemplary method 1800 for rapid predictive analysis of very large data sets using an actor-driven distributed computational graph, according to one aspect. In an initial step 1801, a DCG 100 defines a data context for an activity, determining how the activity handles data that is passed to it. The activity then, according to the context definition, receives data and forwards it 1802 to the next step in the data pipeline. The data is then 1803 passed to a messaging system 210 that acts as a central data broker, receiving the data and passing it on 1804 to the next activity actor in the pipeline, which may then have a context assigned 1801 so that operation continues as shown. This allows brokered, centralized messaging between activity actors within data pipelines, using a messaging system 210 to bridge communication between different actors.

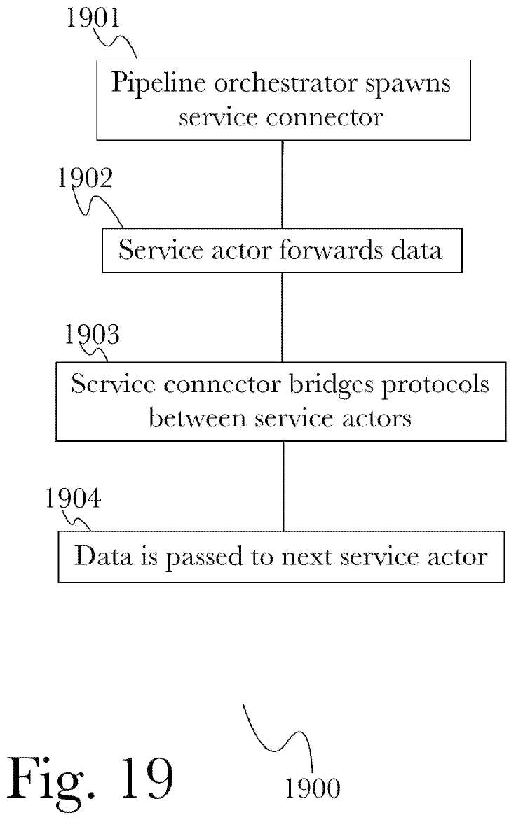

FIG. 19 is a process flow diagram for an exemplary method 1900 for rapid predictive analysis of very large data sets using an actor-driven distributed computational graph, according to one aspect. In an initial step 1901, a pipeline orchestrator 101 may spawn a plurality of service connectors 410, each of which is configured to bridge communication between two or more service actors 221a-d for peer-to-peer messaging without using a messaging system 210 as a central broker. When a service actor 221a-d forwards data 1902 to another service actor 221a-d, an appropriate service connector 410 may receive the data and perform any necessary interpretation or modification to bridge service protocols 1903 between the source and destination service actors 221a-d. The modified data may then be provided 1904 to the destination service actor 221a-d. Service connectors may be created and destroyed as needed without impacting other operations, producing a scalable and on-the-fly peer-to-peer messaging system that does not rely on any centralized broker to relay messages and permits direct communication between actors.

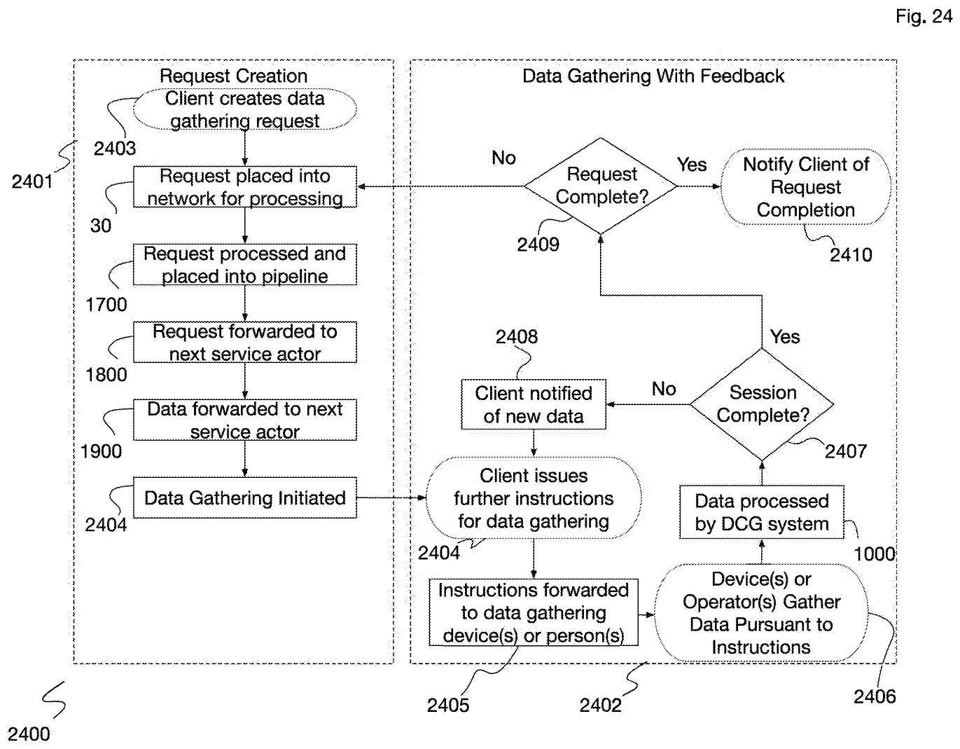

FIG. 24 is a process flow diagram for an exemplary embodiment 2400 of the data gathering system. In the request creation application 2401, the client creates a data gathering request 2403. This initial data gathering request will specify the basic parameters of the data gathering task, such as the location, the type of data to be gathered, the method of collection, the frequency, and other parameters, plus the compensation to operators for providing parts of the requested data. This request is placed into the DCG system 30 for processing as previously disclosed. The request is then processed, and several steps are taken in sequence or in parallel as previously disclosed: the request is placed into the pipeline 1700 and forwarded to the next service actor 1800, along with the necessary data for action 1900. Once the processing is complete, the data gathering procedure 2402 is initiated. The data gathering procedure is iterative, with successive operations being repeated until that particular data gathering session is complete. Upon initiation of the data gathering procedure and at each iteration of the session, the client may issue further instructions 2404 regarding collection of the data for that session, for example: instructions to the operator to collect additional samples, instructions to pan the camera left, instructions to zoom in on a particular subject of interest, and similar instructions. Said instructions are forwarded to the device or operator 2405, who then gathers the data as requested 2406 and in accordance with the most recent instructions. Said data are passed back through the DCG system for processing 1000 as previously disclosed. The system then makes an assessment as to whether this data gathering session is complete 2407. If it is not complete, the client is notified of the new data collected 2408, and the process repeats, starting with further instructions from the client. If it is complete, a further assessment is made to determine if the entire data gathering request is complete 2409. If it is not complete, the session is ended, but the data gathering request is placed back into the DCG system for further data gathering. If it is complete, the client is notified that the request is complete 2410.

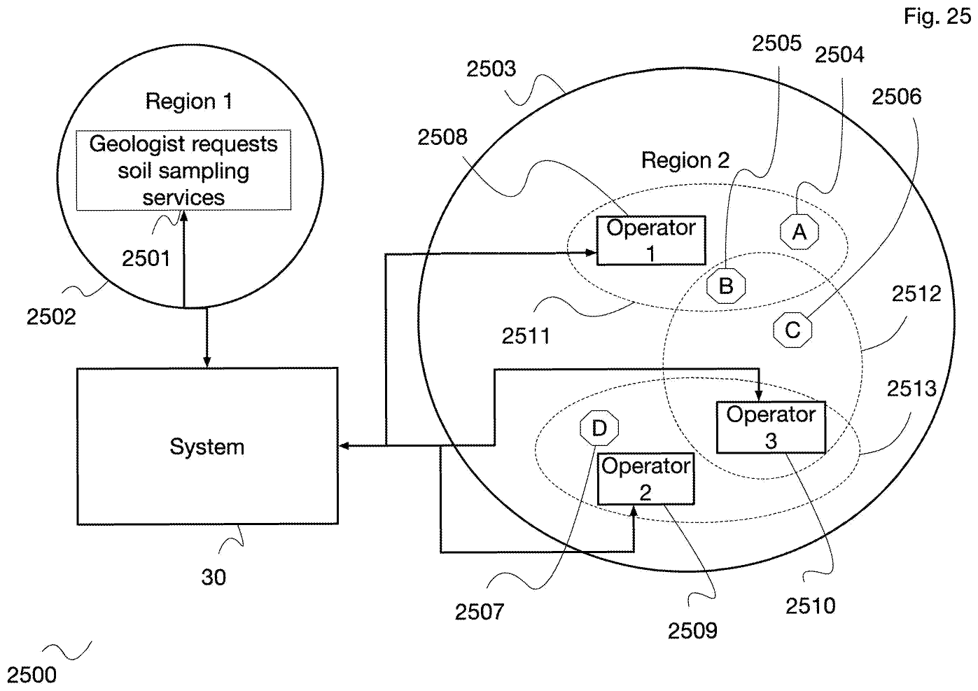

FIG. 25 is a diagram showing an exemplary use 2500 of an embodiment of the data gathering system. Say, for example, that a geologist 2501 in Region 1 2502 needs to have soil samples collected at several times throughout the year in Region 2 2503, a location remote from him. The samples need to be taken at 4 locations: site A 2504, site B 2505, site C 2506, and site D 2507. When the geologist creates his data gathering request, it is sent to the DCG system 30 for processing as previously disclosed. The system forwards data gathering requests to operators whom it predicts based on past behavioral and location data will be willing and able to collect data from at least one of the sites during at least one of the times requested by the geologist. Operator 1 2508 lives in the area, and has participated in similar gathering requests in the past. The system predicts, based on prior information, that Operator 1 will be able to perform data gathering services from a general area 2511 that includes sites A and B, and sends requests to Operator 1 accordingly. Operator 2 2509 will be on vacation in the area on certain dates, and the system predicts that Operator 2 would be willing and able to perform data gathering services from a general area 2513 that includes site D. Operator 3 2510 has relatives in the area, and based on past information, the system believes that Operator 3 would be willing and able to perform data gathering services from a general area 2512 that includes sites B and C. Thus, there is a network of individuals who have agreed to provide data gathering services and who have various connections to the location where the data is to be gathered. Collectively, they are likely to obtain samples from all four sites of interest during the times requested by the geologist without the geologist having to establish a presence in the area or place his own monitoring devices at the sites.

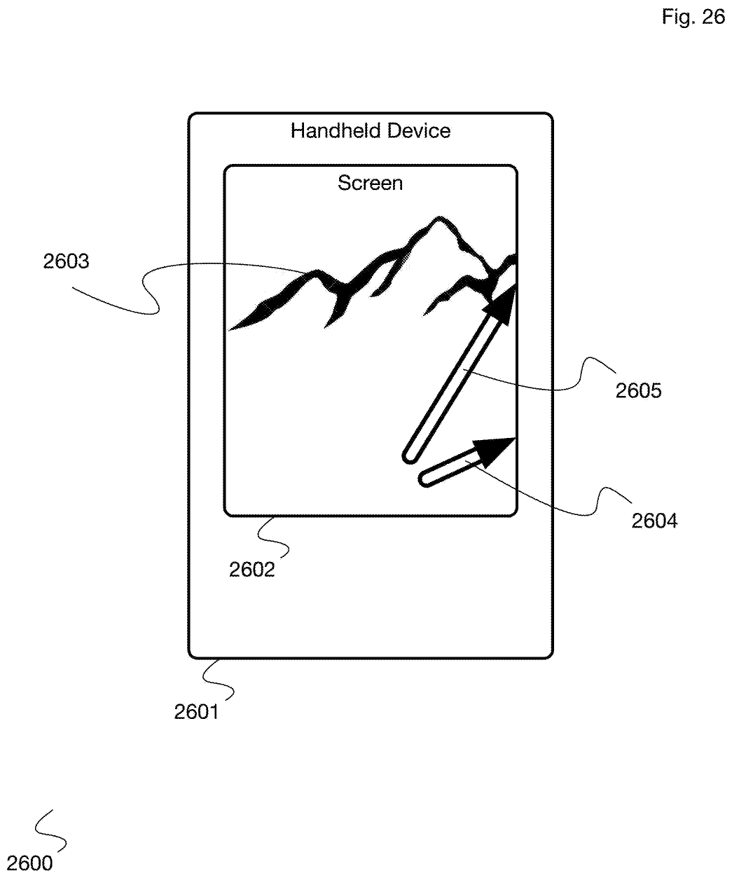

FIG. 26 is a diagram showing an exemplary representation of the client direction and operator visual feedback aspect of a video streaming embodiment 2600 of the data gathering system. A device 2601, likely a mobile phone, is held by an operator, who points the device's video camera at a data gathering subject requested by a client. The device's screen 2602 opposite the video camera, shows the current video feed 2603 both to the operator directly, and to the client via real-time video streaming. The client uses an indicating mechanism such as a computer mouse to indicate in real time directions for movement of the camera to the operator. The client's directions show up on the device's screen as vector arrows with a magnitude and direction for the camera to be moved. For example, the arrow at 2604 shows that the camera should be moved slightly up and to the right. As another example, the arrow at 2605 shows that the camera should be moved substantially upward and to the right. Compliance with these onscreen instructions can be measured in terms of time for compliance and accuracy, and scores can be given which will, in part, determine the operator's compensation for this data gathering session.

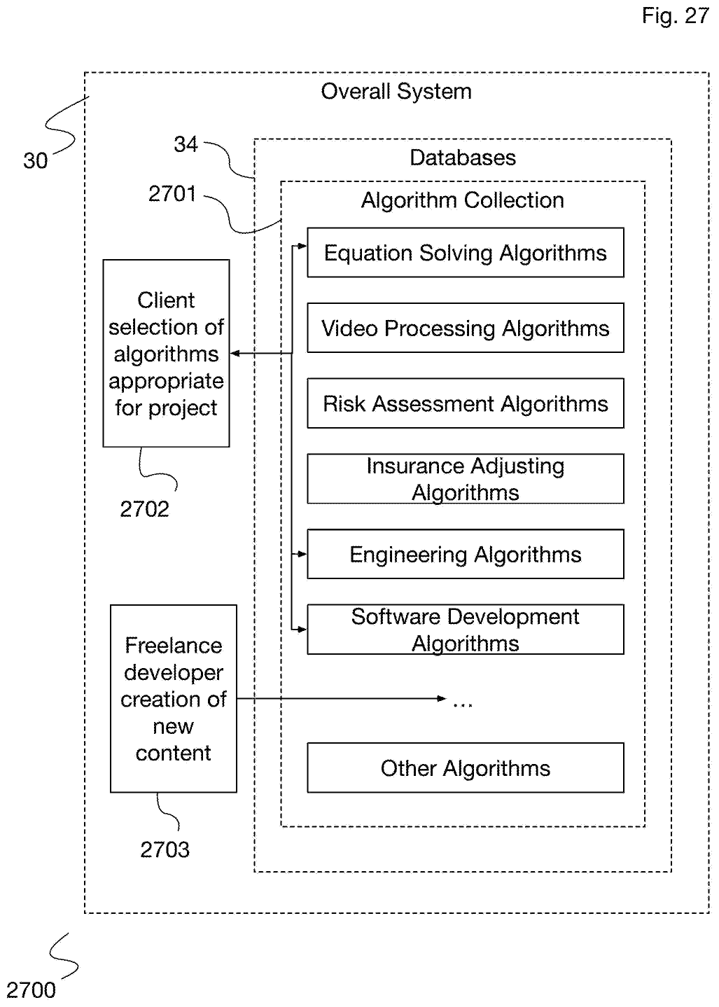

FIG. 27 is a process flow diagram showing an exemplary representation of a universal collection of computing algorithms and a marketplace for clients and developers of such algorithms 2700. In the context of a previously disclosed embodiment 30, and within the database portion of said embodiment 34, exists a universal collection of algorithms 2701, that can be selected for use by a client 2702 separately or in combination with other algorithms for the purpose of meeting the client's specific computing needs. Freelance developers 2703 will be encouraged to contribute additional content to the system for a fee, royalties, or other compensation, thus ensuring that the collection continues to grow and remain up to date.

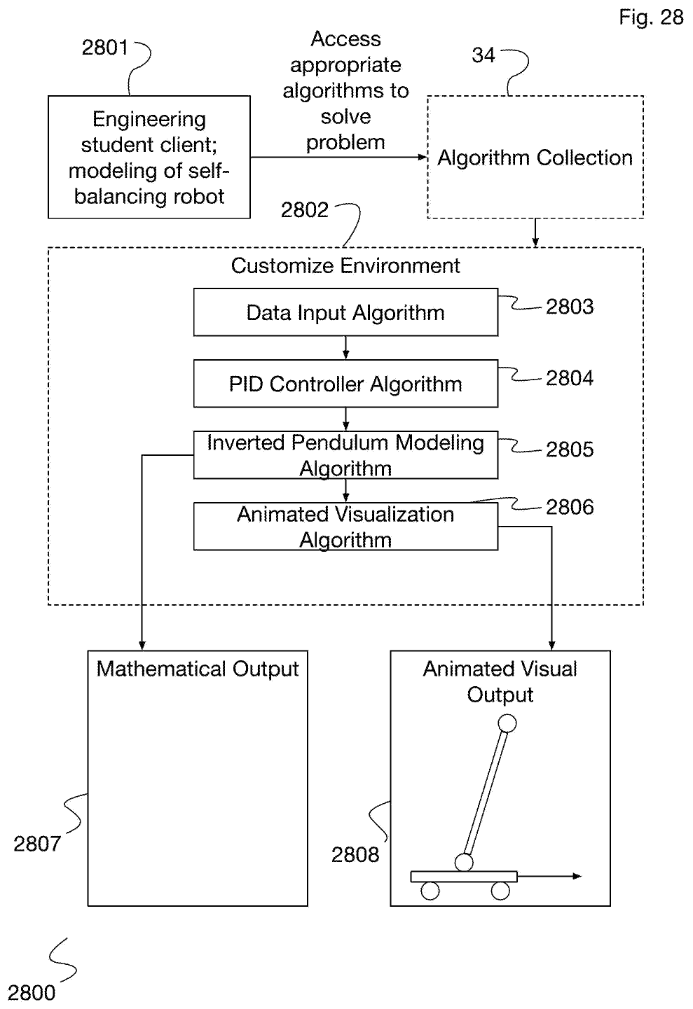

FIG. 28 is a diagram showing an exemplary representation of the usage of a universal collection of computing algorithms by an individual client with simple computing needs 2800. In this example, a university engineering student 2801 needs to perform repeated simulations of a self-balancing robot under a variety of conditions. Through the use of APIs available in the system, the student customizes his work environment 2802 and selects appropriate algorithms from the previously disclosed collection 34 to perform the needed computing. The student combines, in a modular way, algorithms for inputting data 2803, adjusting the parameters of the proportional/integral/differential (PID) controller 2804, modeling an inverted pendulum 2805, running a visualization algorithm 2806, and outputting both mathematical 2807 and animated visual outputs 2808 of the results.

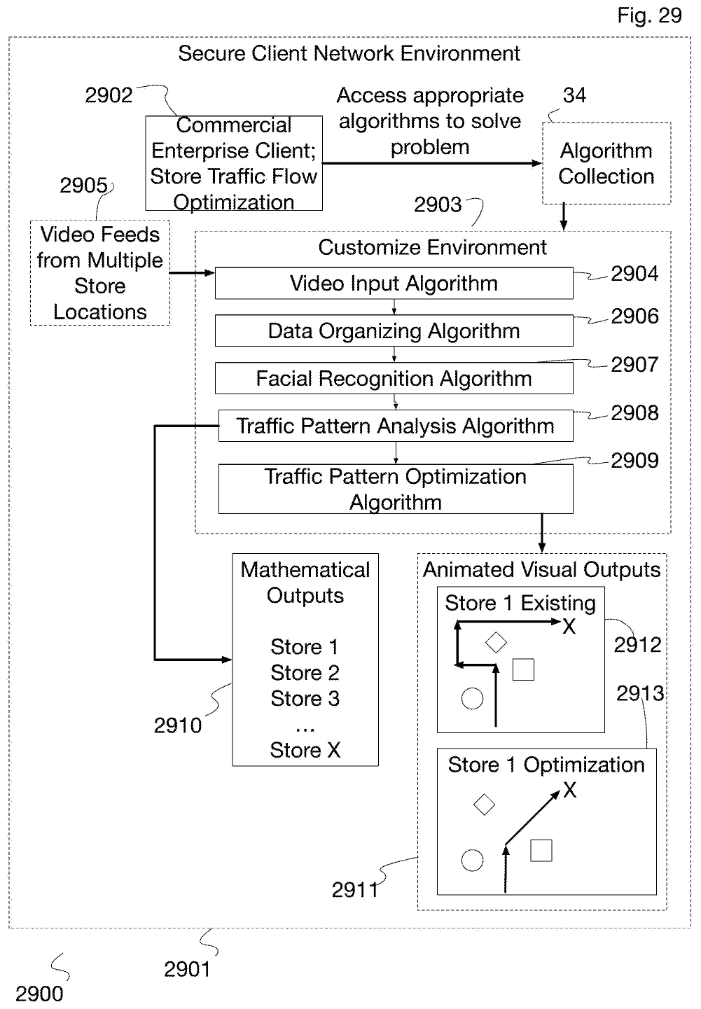

FIG. 29 is a diagram showing an exemplary representation of the usage of a universal collection of computing algorithms by a large commercial enterprise client with complex computing needs 2900. In this example, a commercial client 2902 needs to analyze the video feed from hundreds of security cameras 2905 located at its many business locations worldwide to analyze the flow of consumer traffic through its stores. Within the client's secure network environment 2901, which is integrated with the system, the client customizes his work environment 2903 and through the use of APIs available in the system, selects appropriate algorithms from the previously disclosed collection 34 to perform the needed computing. The client combines in a modular steps algorithms for obtaining video input feeds 2904, organizing the gathered video data 2906, processing the video feeds through facial recognition algorithms 2907 to track the movement of people through the store, perform traffic pattern analysis at each store 2908, and run simulations that optimize traffic patterns for each store location 2909. The results are output for each store both in mathematical (raw data) form 2910, and as visual animations 2911 showing the existing 2912 and optimized 2913 store layouts. In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

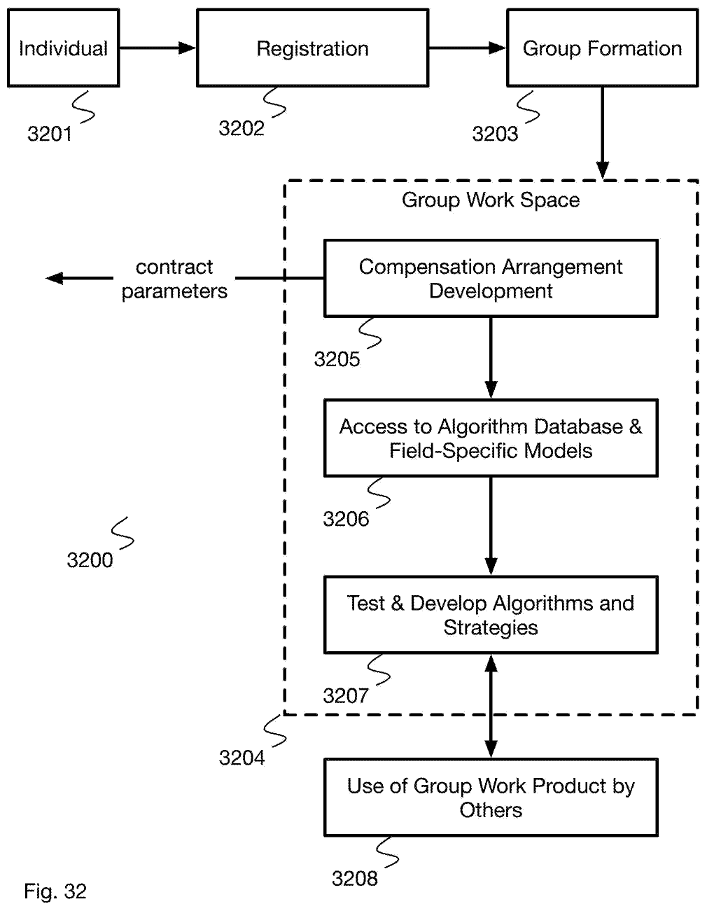

FIG. 32 is a process flow diagram showing the major steps involved in use of an embodiment of a collaborative algorithm development, deployment, and tuning platform as applied to the field of quantitative securities trading 3200 by individuals and groups. An individual 3201 wishing to use the platform signs up in the registration area 3202, and optionally proceeds to form groups 3203 with other like-minded individuals. After formation of a group 3203 or bypassing that step, the workspace 3204 can be accessed, in which the individual or group proposes a compensation arrangement for its work 3205. The platform allows for flexible compensation arrangements, such as royalties, licensing, commissions, etc., which may be accepted by potential users of the individual's or group's work product by using the work product. Once a compensation arrangement has been created, the terms of the contract are sent to the previously disclosed smart contract manager 3108, which incorporates the contract parameters into the smart contract for that project. After compensation arrangement development 3205, the individual or group is provided access to the algorithm database and any field-specific models 3206 that are necessary to test and develop algorithms and strategies 3207, which constitute the work product of the individual or group, and are made available in the overall platform for use by others 3208.

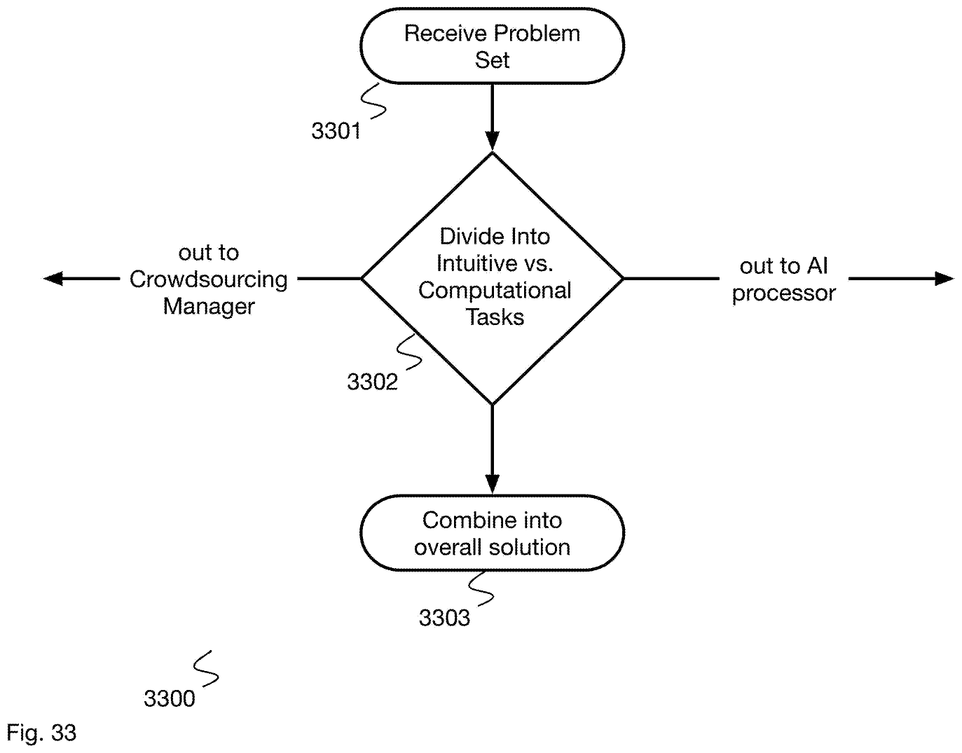

FIG. 33 is a process flow diagram showing the major steps involved in use of a collaborative algorithm development, deployment, and tuning platform 3300 involving allocation of tasks depending on whether they are intuitive or computational in nature. As problem sets are received 3301, they are analyzed for components that are primarily intuitive in nature versus computational tasks, and are divided into tasks accordingly 3302. Computationally intensive tasks are sent to the previously disclosed AI processor 3005 for handling, and intuitively based tasks are sent to the previously disclosed crowdsourcing manager 3002. When solutions are received back from the AI processor 3005 and the crowdsourcing manager 3002, they are combined into an overall solution 3303 to the problem set.

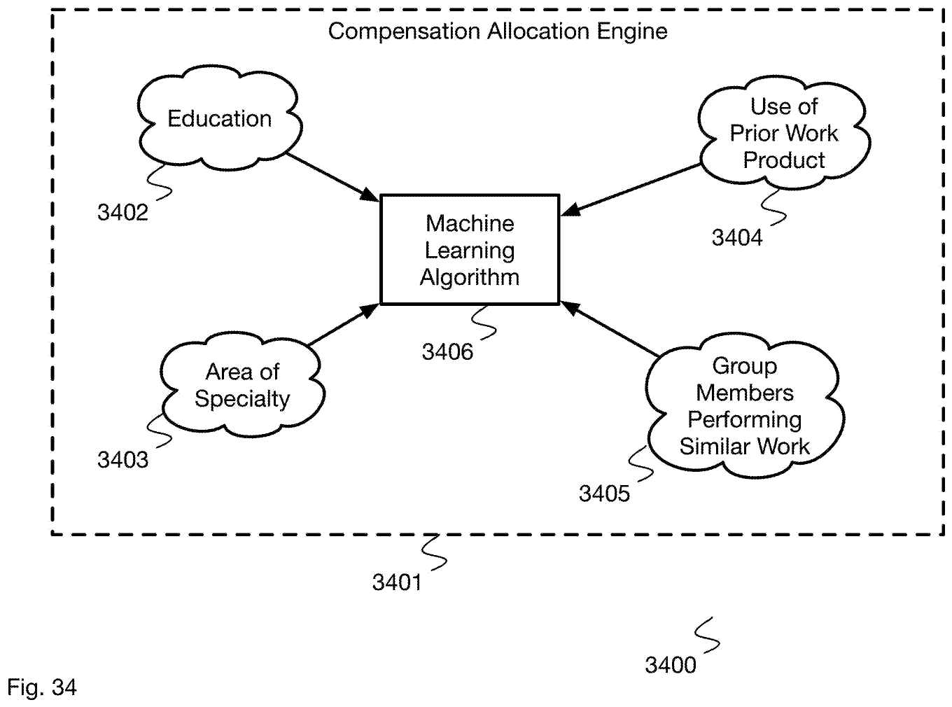

FIG. 34 is a conceptual diagram of the types of inputs that will be used an aspect of a collaborative algorithm development, deployment, and tuning platform 3400, the compensation allocation engine 3401, to allocate compensation among the group members based on a predictive calculation of that member's expected contributions in developing algorithms and strategies. The compensation allocation engine functions in a manner analogous to the “wins above replacement” model used in baseball to assign a predictive value to a player's contributions to the team. In the wins above replacement model, a player's value to the team is determined by his abilities and past performance and converted to a number of additional wins for the team that player would generate in excess of a “typical” replacement player. Likewise, the compensation allocation engine would use inputs such as a group member's education 3402, area of specialization 3403 in relation to the problem set, the number of group members performing similar functions 3404, and the use of the individual's prior work product 3405 in the platform. These inputs would be combined into a machine learning algorithm 3406 to assign a predictive value of that individual's contributions to the group, which would then be encoded as contract parameters by the previously disclosed smart contract manager 3108.

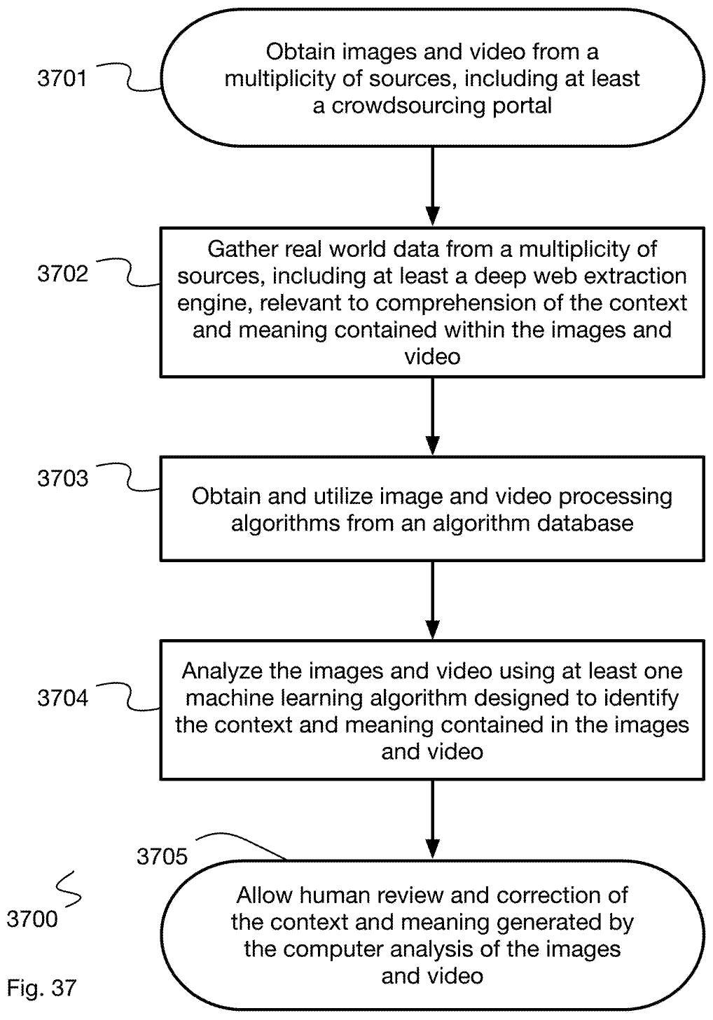

FIG. 37 is a process flow diagram illustrating a method 3700 for recognizing, classifying, and processing the context and meaning of images and video in a manner similar to human intuitive understanding of such context and meaning. Images and video would be obtained from a multiplicity of sources, including at least a crowdsourcing portal 3701. Real world data would be gathered from a multiplicity of sources, including at least a deep web extraction engine, relevant to comprehension of the context and meaning contained within the images and video 3702. Image and video processing algorithms would be obtained from an algorithm database 3703. Using the algorithms and real-world data, the images and video would be analyzed using at least one machine learning algorithm designed to identify the context and meaning contained in the images and video 3704. Finally, the computer-generated analysis would be subject to human review and correction 3705, improving the machine learning algorithm's accuracy in future analyses.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

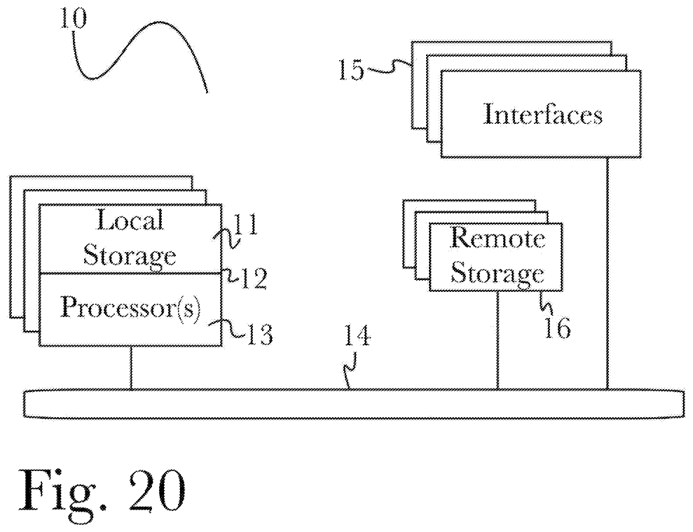

Referring now to FIG. 20, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 20 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine- readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

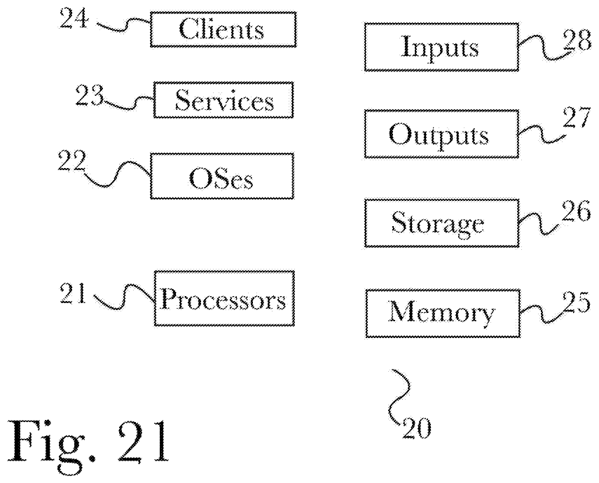

In some aspects, systems may be implemented on a standalone computing system. Referring now to FIG. 21, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 20). Examples of storage devices 26 include flash memory, magnetic hard drive, CD-ROM, and/or the like.

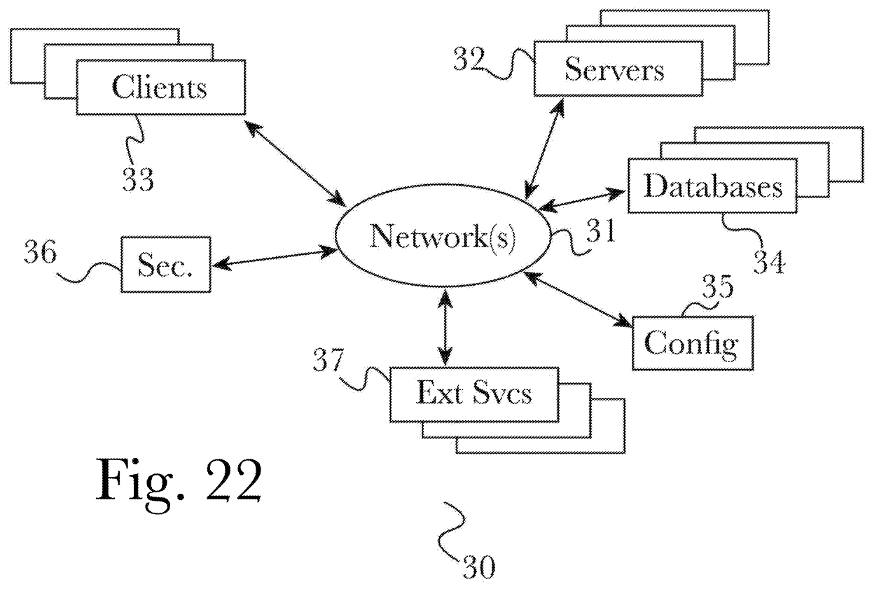

In some aspects, systems may be implemented on a distributed computing network, such as one having any number of clients and/or servers. Referring now to FIG. 22, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 21. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some aspects, clients 33 or servers 32 (or both) may make use of one or more specialized services or appliances that may be deployed locally or remotely across one or more networks 31. For example, one or more databases 34 may be used or referred to by one or more aspects. It should be understood by one having ordinary skill in the art that databases 34 may be arranged in a wide variety of architectures and using a wide variety of data access and manipulation means. For example, in various aspects one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

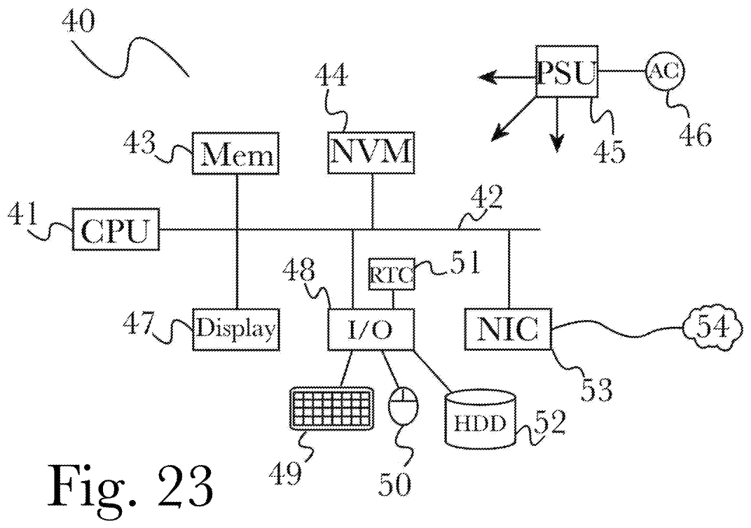

FIG. 23 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

The skilled person will be aware of a range of possible modifications of the various aspects described above. Accordingly, the present invention is defined by the claims and their equivalents.

What is claimed is:

1. A computing system for analysis of images and video that is capable of recognizing, classifying, and processing the context and meaning contained therein in a manner similar to human intuitive understanding of such context and meaning employing a collaborative platform, the computing system comprising:
one or more hardware processors configured for:
receiving image and video data from a first plurality of sources;
allowing individuals and groups to review and annotate classifications and metadata associated with the received image and video data;
gathering data from a second plurality of sources on the internet;
retrieving real-world data based at least in part on the received images and video from the second plurality of sources;
obtaining one or more machine learning algorithms from an algorithm database; and
analyzing the received images and video using the retrieved machine learning algorithms to classify and add metadata to the received image and video data.

2. The computing system of claim 1, wherein the first plurality of sources comprises crowdsourced or collaborative data sources.

3. A computer-implemented method executed on a collaborative platform for analysis of images and video that is capable of recognizing, classifying, and processing the context and meaning contained therein in a manner similar to human intuitive understanding of such context and meaning, the computer-implemented method comprising:
receiving image and video data from a first plurality of sources;
allowing individuals and groups to review and annotate classifications and metadata associated with the received image and video data;
gathering data from a second plurality of sources on the internet;
retrieving real-world data based at least in part on the received images and video from the second plurality of sources;
obtaining one or more machine learning algorithms from an algorithm database; and
analyzing the received images and video using the retrieved machine learning algorithms to classify and add metadata to the received image and video data.

4. The method of claim 3, wherein the first plurality of sources comprises crowdsourced or collaborative data sources.

5. A system for analysis of images and video that is capable of recognizing, classifying, and processing the context and meaning contained therein in a manner similar to human intuitive understanding of such context and meaning employing a collaborative platform, comprising one or more computers with executable instructions that, when executed, cause the system to:
receive image and video data from a first plurality of sources;
allow individuals and groups to review and annotate classifications and metadata associated with the received image and video data;
gather data from a second plurality of sources on the internet;
retrieve real-world data based at least in part on the received images and video from the second plurality of sources;
obtain one or more machine learning algorithms from an algorithm database; and
analyze the received images and video using the retrieved machine learning algorithms to classify and add metadata to the received image and video data.

6. The system of claim 5, wherein the first plurality of sources comprises crowdsourced or collaborative data sources.

7. Non-transitory, computer-readable storage media having computer-executable instructions embodied thereon that, when executed by one or more processors of a computing system employing a collaborative platform for analysis of images and video that is capable of recognizing, classifying, and processing the context and meaning contained therein in a manner similar to human intuitive understanding of such context and meaning, cause the computing system to:
receive image and video data from a first plurality of sources;
allow individuals and groups to review and annotate classifications and metadata associated with the received image and video data;
gather data from a second plurality of sources on the internet;
retrieve real-world data based at least in part on the received images and video from the second plurality of sources;
obtain one or more machine learning algorithms from an algorithm database; and
analyze the received images and video using the retrieved machine learning algorithms to classify and add metadata to the received image and video data.

8. The non-transitory computer-readable storage media of claim 7, wherein the first plurality of sources comprises crowdsourced or collaborative data sources.
